(19) United States
(12) Patent Application Publication
(10) Pub. No.: US 2011/0087534 A1
(43) Pub. Date: Apr. 14, 2011

(54) SEARCH QUERIES AND ADVERTISING PLATFORMS UTILIZING AT LEAST ONE SOCIAL GRAPH

(75) Inventors: David Robert Strebinger, Vancouver (CA); Nigel Cramond Malkin, Vancouver (CA)

(73) Assignee: WANTSA MEDIA (CANADA), INC., Vancouver (CA)

(21) Appl. No.: 12/730,624

(22) Filed: Mar. 24, 2010

Related U.S. Application Data
(60) Provisional application No. 61/251,694, filed on Oct. 14, 2009.
(60) Provisional application No. 61/251,943, filed on Oct. 15, 2009.
(60) Provisional application No. 61/267,797, filed on Dec. 8, 2009.

(51) Int. Cl. G06Q 30/00; G06F 17/30; G06Q 99/00

(52) U.S. Cl. 705/14.25; 707/769; 707/722; 705/319; 707/802; 707/E17.014; 707/E17.044; 705/26.7

(57) ABSTRACT

Systems and methods associated with search queries and advertising platforms utilizing at least one social graph and related technologies are presented herein. In one aspect, interactive communications can be disseminated within an online and/or a mobile environment based on at least one social graph. In another aspect, interactive communications, e.g., offer(s) or recommendation(s), can be stored for use in generating further interactive communications, and can be shared with person(s), member(s), organization(s), business(es), and/or advertiser(s) based on the at least one social graph. In yet another aspect, recommendation feeds can be automatically generated based on one-click activations of interactive communications, enabling, e.g., persons to supply recommendations within social networking environment(s) in a “viral” manner. In one aspect, one or more social graphs can be used to provide information to and/or solicit/obtain information from person(s) and/or business(es) associated with one or more social graphs.

### PRIORITY CLAIM

This application claims priority to U.S. Provisional Patent Application Ser. No. 61/251,694, filed on Oct. 14, 2009, entitled “SEARCH QUERIES AND PLATFORM FOR SOCIAL MEDIA ENVIRONMENTS”; U.S. Provisional Patent Application Ser. No. 61/251,943, filed on Oct. 15, 2009, entitled “SEARCH QUERIES AND PLATFORM FOR SOCIAL MEDIA ENVIRONMENTS”; and U.S. Provisional Application Ser. No. 61/267,797, filed on Dec. 8, 2009, entitled “LIVE AND STATIC SEARCH QUERIES AND ADVERTISING PLATFORM FOR SOCIAL MEDIA ENVIRONMENTS.” The entirety of the aforementioned applications is incorporated by reference herein.

### TECHNICAL FIELD

This disclosure relates generally to utilizing at least one social graph including, but not limited to search queries and advertising platforms utilizing at least one social graph, and related technologies.

### BACKGROUND

Social media enable social interaction, e.g., via mobile, Internet, web-based, and/or network technologies. Such technologies include many forms, e.g., cellular phones, personal data assistants (PDAs), Internet forums, blogs, podcasts, wall-postings, email, instant messaging (IM), short message service (SMS) messages, multimedia messaging service (MMS) messages, etc. and provide social networking environments that can be utilized by associated friends, family, businesses, coworkers, etc. For example, Facebook™, MySpace™, and Twitter™ are conventional social networking environments that can be used by people and/or businesses to stay connected with each other.

Some of such social media environments link associated members via a social graph, which is an extended network of individuals, organizations, and/or businesses connected, or linked, for example, to members of a social network environment. Although conventional social network environments enable businesses to communicate via one-to-many advertising, e.g., via banner advertisements posted within a web page, such environments do not enable interactive, many-to-many dialogue(s) between person(s), advertiser(s), organization(s), and/or business(es) and other person(s), advertiser(s), organization(s), and/or business(es). Further, such environments do not enable effective monetization of search-related advertising, e.g., since users of social network environments typically perform online searches utilizing various search engines, e.g., Google™, etc. outside of the social networking environments.

The above-described deficiencies of today's search query and advertising platform environments and related technologies are merely intended to provide an overview of some of the problems of conventional technology, and are not intended to be exhaustive. Other problems with the state of the art, and corresponding benefits of some of the various non-limiting embodiments described herein, may become further apparent upon review of the following detailed description.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject innovations. Its sole purpose is to present some concepts of the disclosed subject matter in a simplified form as a prelude to the more detailed description presented later.

Although conventional social network environments enable banner advertising and click-through-advertising, such advertising techniques are one-way communications designed to enable a viewer and/or consumer to click on, and be directed to, a new page, e.g., webpage, splashpage, signup page, etc. away from where the one-way communications are presented and/or displayed. As such, conventional social network environments do not enable person(s), advertiser(s), organization(s), and/or business(es) to communicate with other person(s), advertiser(s), organization(s), and/or business(es) via interactive communication(s) and/or message(s), e.g., via interactive conversation feed(s), posted within a social media.

For example, conventional social media do not enable person(s), advertiser(s), organization(s), and/or business(es) to communicate with other person(s), advertiser(s), organization(s), and/or business(es) via interactive, many-to-many, conversation feeds associated with a wall space, or wall, e.g., an area of space on a profile page associated with a social media. Such interactive, many-to-many, conversation feeds can include offer(s), petition(s) for offer(s), etc. that can be seen and/or engaged upon, e.g., via a wall, by person(s), advertiser(s), organization(s), and/or business(es) associated with the social media.

Further, conventional social media do not enable person(s), organization(s), and/or business(es) to monetize communications, e.g., conversation feeds, occurring within such social media. Furthermore, conventional search query and/or advertising platforms do not leverage social graph(s) to provide information, i.e., advertising, recommendation(s), service(s) to person(s) and/or business(es) associated with the social graph(s). Moreover, conventional search query and/or advertising platforms do not leverage the social graph(s) to solicit/obtain information from the person(s) and/or the business(es), i.e., via surveys. To correct for these and other drawbacks of conventional search query and/or advertising environments and related technologies, various systems and methods described herein utilize search-based, recommendation-based, and/or advertising-based interactive communication feeds disseminated and/or communicated, e.g., via a social network environment to persons(s), organization(s), advertiser(s), and/or business(es) associated with the social network environment—based on one or more social graphs associated with such an environment. Further, various systems and methods described herein utilize one or more social graphs to provide information to and/or to solicit/obtain information from person(s) and/or business(es) associated with the one or more social graphs.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a block diagram of a social networking environment, in accordance with an embodiment.

FIG. 2 illustrates another block diagram of a social networking environment, in accordance with an embodiment.

FIG. 3 illustrates yet another block diagram of a social networking environment, in accordance with an embodiment.

FIG. 4 illustrates creating a search feed within a social networking environment, in accordance with an embodiment.

FIG. 5 illustrates a search feed, in accordance with an embodiment.

FIG. 6 illustrates a social networking environment including walls, in accordance with an embodiment.

FIG. 7 illustrates a social networking environment including a suggestion interface, in accordance with an embodiment.

FIG. 8 illustrates a recommendation feed, in accordance with an embodiment.

FIG. 9 illustrates a social networking environment including recommendation feeds, in accordance with an embodiment.

FIG. 10 illustrates a confirmation feed, in accordance with an embodiment.

FIG. 11 illustrates a social networking environment including confirmation feeds, in accordance with an embodiment.

FIG. 12 illustrates an offer petition feed, in accordance with an embodiment.

FIG. 13 illustrates creating an offer feed within a social networking environment, in accordance with an embodiment.

FIG. 14 illustrates an offer feed, in accordance with an embodiment.

FIG. 15 illustrates a social networking environment including an offers wall, in accordance with an embodiment.

FIG. 16 illustrates a social networking environment including a search results wall, in accordance with an embodiment.

FIG. 17 illustrates a sorting environment, in accordance with an embodiment.

FIG. 18 illustrates a verification feed, in accordance with an embodiment.

FIG. 19 illustrates an action feed, in accordance with an embodiment.

FIGS. 20-29 illustrate various processes associated with one or more social networking environments, in accordance with an embodiment.

FIG. 30 illustrates a system for utilizing social graph(s), in accordance with an embodiment.

FIG. 31 illustrates providing and/or soliciting information utilizing social graph(s), in accordance with an embodiment.

FIGS. 32-39 illustrate a mobile device implementing aspects of exemplary process(es), in accordance with an embodiment.

FIG. 40 illustrates a block diagram of a computing system operable to execute the disclosed systems and methods, in accordance with an embodiment.

### DETAILED DESCRIPTION

Various non-limiting embodiments of systems and methods presented herein utilize one or more social graphs, e.g., associated with a social network environment, to provide information to and/or solicit/obtain information from person(s) and/or business(es) associated with the one or more social graphs.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal). As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via social media component 130 (described below), to automatically evaluate a query based on at least one social graph. In another example, the artificial intelligence system can be used, via social media component 130, to intelligently complete and/or suggest words, phrases, etc. to be entered into a query input area as one or more characters associated with a query are typed into the query input area. In yet another example, when an active sharing feature (described below) is enabled, the artificial intelligence system can be used, via social component 130, to automatically share one or more offers sent to a person with other person(s).

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example. Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-Ray Disc™ (BD)); smart card(s); and flash memory device(s) (e.g., card, stick, key drive).

As described above, conventional search query and/or advertising platforms do not leverage social graph(s) to provide information, i.e., advertising, recommendation(s), service(s) to person(s) and/or business(es) associated with the social graph(s). Moreover, conventional search query and/or advertising platforms do not leverage the social graph(s) to solicit/obtain information from the person(s) and/or the business(es). Further, conventional social network environments do not enable person(s), business(es), organization(s), advertiser(s), etc. to communicate with other person(s), business(es), organization(s), advertiser(s), etc. via ongoing conversation(s) between a user, member(s), organization(s), business(es), and/or advertiser(s) associated with a social network environment—based on a social graph associated with such an environment. Accordingly, the user, member(s), organization(s), business(es), and/or advertiser(s) can engage in a dialog, e.g., with potential consumer(s).

For example, conventional social networks do not enable one or more businesses to communicate with one or more consumers via many-to-many communications posted within a wall space, e.g., space on a profile page of a user associated with a social network environment. Further, such environments do not enable person(s), business(es), organization(s), advertiser(s), etc. to monetize interactive communications occurring within social network environments, e.g., social media. For example, advertisers, organizations, and/or businesses cannot participate in a dialogue between members of a conventional social network environment within such an environment. Rather, e.g., the advertisers, organizations, and/or businesses can merely include an image, text, and/or link to an associated website, e.g., via one-to-many advertising.

Compared to such technology, various systems and methods described herein can activate ongoing conversation(s) between a user, member(s), organization(s), business(es), and/or advertiser(s) associated with a social network environment—based one or more social graphs associated with such an environment. Accordingly, the user, member(s), organization(s), business(es), and/or advertiser(s) can engage in a dialog, e.g., with potential consumer(s). Moreover, various systems and methods described herein can utilize one or more social graphs to provide information to and/or solicit/obtain information from person(s) and/or business(es) associated with one or more social graphs.

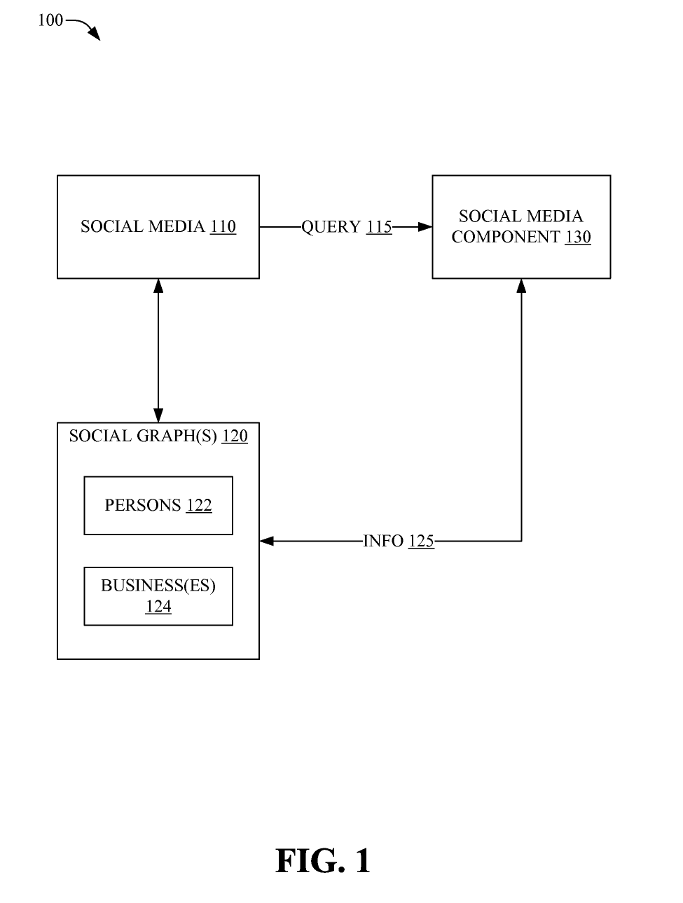

Referring now to FIG. 1, a block diagram of a social networking environment 100 is illustrated, in accordance with an embodiment. Aspects of social network environment 100, and other social networking environments, networks, systems, apparatus, and processes explained herein can constitute machine-executable instructions embodied within a machine, e.g., embodied in a computer readable medium associated with the machine. Such instructions, when executed by the machine, e.g., computer, computing device, etc. can cause the machine to perform the operations described. Moreover, it should be appreciated that various aspects and/or features of the disclosed subject matter can be implemented, e.g., via a desktop and/or mobile computer, e.g., wireless mobile communications device, connected to the Internet. In addition, it should be appreciated that various aspects and/or features of the disclosed subject matter can be implemented, e.g., without connection to the Internet, e.g., via SMS and/or MMS message-based feeds disseminated and/or communicated to person(s), business(es), organization(s), advertiser(s), etc. associated with one or more social graphs, e.g., via a social media.

Additionally, the systems and processes can be embodied within hardware, such as an application specific integrated circuit (ASIC) or the like. Further, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Social networking environment 100 includes social media 110, social graph(s) 120, and social media component 130. Social networking environment 100 can include various social networking environments utilizing technologies including, for example, cellular phone(s), PDAs, Internet forums, blogs, podcasts, wall-postings, email, IM, SMS, MMS, etc., which can be used by, e.g., associated friends, family, organizations, businesses, coworkers, etc. In an aspect, social media 110 can include a social networking environment such as, for example, Facebook™, MySpace™, and/or Twitter™. In another aspect, the social networking environment can comprise non-internet-based communication platform(s) based on, for example, email, IM, SMS, MMS, etc. communication feeds disseminated and/or communicated between person(s), business(es), organization(s), advertiser(s), etc. associated with the social networking environment.

Social media 110 is associated with one or more social graph(s) 120, which can define a link, relationship, level of relationship, degree of separation, etc., for example, between persons 122 and business(es) 124 of social networking environment 100 associated with social media 110. In one aspect (not shown), social graph(s) 120 can define a degree of separation between person(s), business(es), organization(s), and/or advertiser(s) associated with social media 110.

In an aspect, social media component 130 can receive a query 115, e.g., a request for a product or service, via social media 110 from a person of two or more persons, e.g., persons 122, associated with at least one social graph, e.g., social graph(s) 120. Social media component 130 can evaluate query 115 based on, at least in part, social graph(s) 120, e.g., utilizing info 125 associated with social graph(s) 120. In this way, social media component 130 can facilitate a direct dialog, e.g., between persons 122, e.g., customers, searching for products and/or services and business(es) 124 interested in targeting such customers—since persons 122 and business(es) 124 are linked within social media 110 via social graph(s) 120. In another aspect (not shown), social media component 130 can be enabled to facilitate a direct dialog between person(s), business(es), organization(s), and/or advertiser(s) linked with social media 110 via social graphs(s) 120.

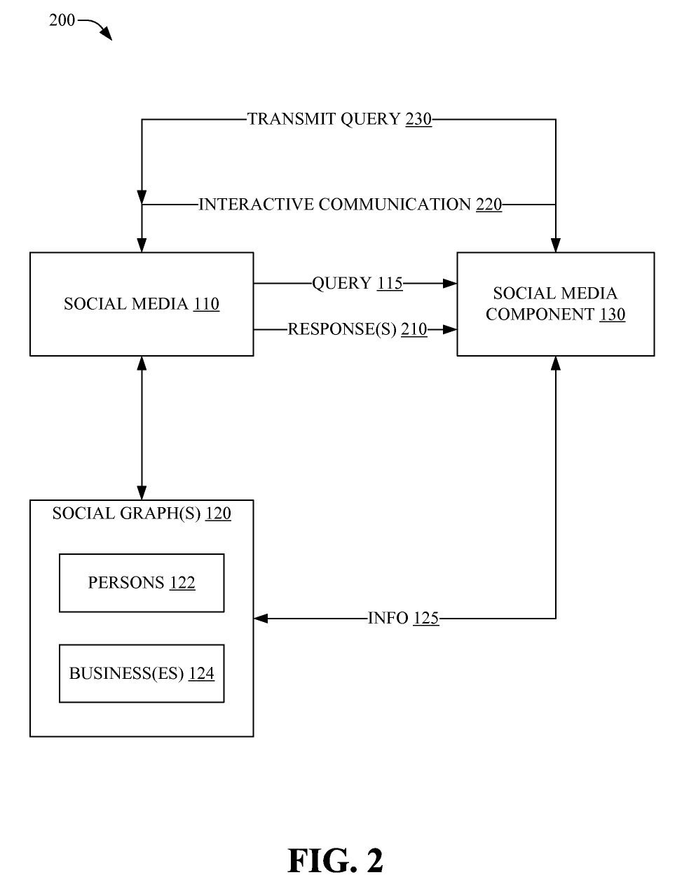

Now referring to FIG. 2, another block diagram of a social networking environment (200) is illustrated, in accordance with an embodiment. Social media component 130 can transmit query 115 via social media 110, e.g., via transmit query 230, to (1) other person(s) of the two or more persons, e.g., persons 122, and/or to (2) at least one business and/or organization that is subscribed to social media 110, e.g., a business of business(es) 124, based on at least one social graph, e.g., social graph(s) 120. Further, social media component 130 can determine whether at least one person of the other person(s) or the at least one business and/or organization submitted a response, e.g., response(s) 210, to query 115. In one aspect, response(s) 210 can include a recommendation of a product and/or service provided by the at least one person. In another aspect, response(s) 210 can include an offer of a product or service provided by the at least one business and/or organization. In yet another aspect, response(s) 210 can include an offer of compensation, e.g., offered by a person, business, organization, etc. in exchange for an action performed by the person who submitted query 115.

Accordingly, social media component 130 can create an interactive communication 220, e.g., recommendation feed, advertisement feed, offer feed, etc. based on, at least in part, whether at least one of the other person(s), and/or the at least one business and/or organization submitted a response, e.g., response(s) 210, to query 115. Further, social media component 130 can communicate and/or disseminate interactive communication 220 via social media 110 to at least one of the person, the other person(s), and/or the at least one business and/or organization. In this way, social media component 130 can enable a real-time, dynamic dialogue, e.g., between consumer(s), organization(s), and/or business(es) who are searching for products and/or services, and/or who are selling products and/or services—based on one or more social graphs linking the consumer(s), organization(s), and/or business(es) via social network environment 200.

In an aspect, social media 110 can include a social networking website. As such, social media component 130 can perform the acts described above in relation to FIG. 2 via the social networking website. In another aspect, social media 110 can include non-internet-based communication platform(s) based on, for example, email, IM, SMS, MMS, etc. Accordingly, social media 130 can perform the acts described above in relation to FIG. 2 via the non-internet-based communication platform(s).

As described above, social graph(s) 120 can define a level of relationship, e.g., degree of separation, between persons 122 of a social networking environment, e.g., social networking environment 200, which can be associated with social media 110. In another embodiment, social media component 130 can disseminate and/or communicate interactive communication 220 via social media 110 to person(s), business(es), organization(s), advertiser(s), etc. based on a degree of separation between the person(s), business(es), organization(s), and/or advertiser(s).

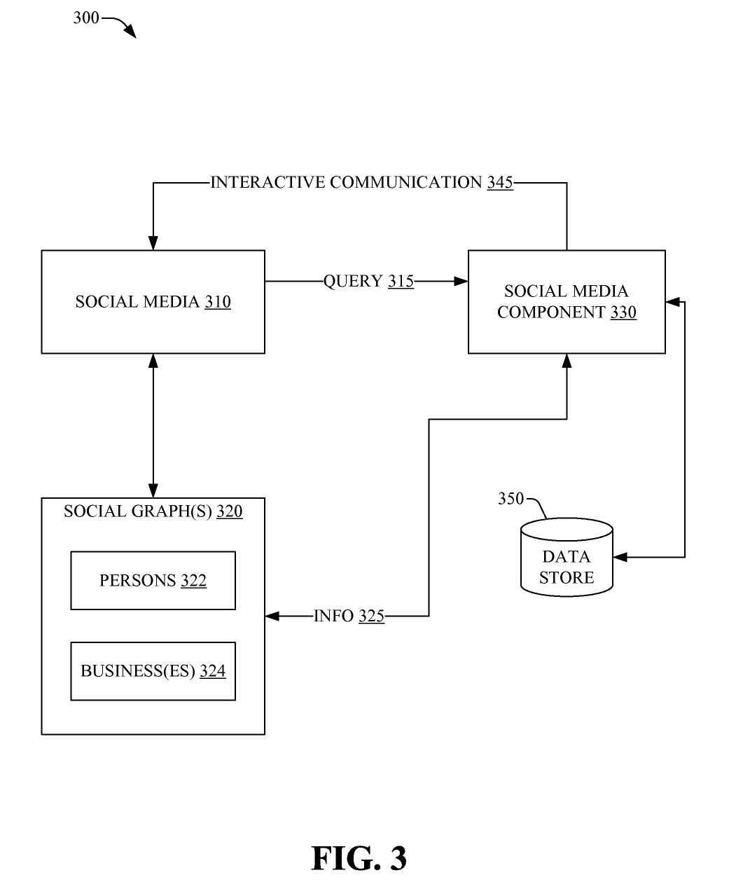

FIG. 3 illustrates a block diagram of a social networking environment (300) including a data store 350, in accordance with an embodiment. Social media component 330 can store information associated with an interactive communication (not shown), e.g., a search feed, a recommendation feed, an advertisement feed, an offer feed, etc. in data store 350. As such, the interactive communication can be archived in data store 350, e.g., for social media components 130, 330, etc. to: present the interactive communication to other users; to utilize in association with future search queries via social media components 130, 330, etc.

For example, social media component 330 can evaluate query 315, e.g., a request for a product and/or service, based on, at least in part, social graph(s) 320 via info 325 and information associated with an interactive communication stored in data store 350 associated with, e.g., a search feed, a recommendation feed, an advertisement feed, an offer feed, etc. Further, social media component 330 can create interactive communication 345, e.g., a recommendation feed, an advertisement feed, an offer feed, etc. based on, at least in part, information associated with a previous interactive communication. Thus, unlike conventional social networking environments, social networking environment 300 can enable “ongoing conversations” related to user search queries via social media 310—compelling a continuation of conversation(s) among a user's social networking community by storing, for example, recommendation(s), advertisement(s), offer(s), etc.

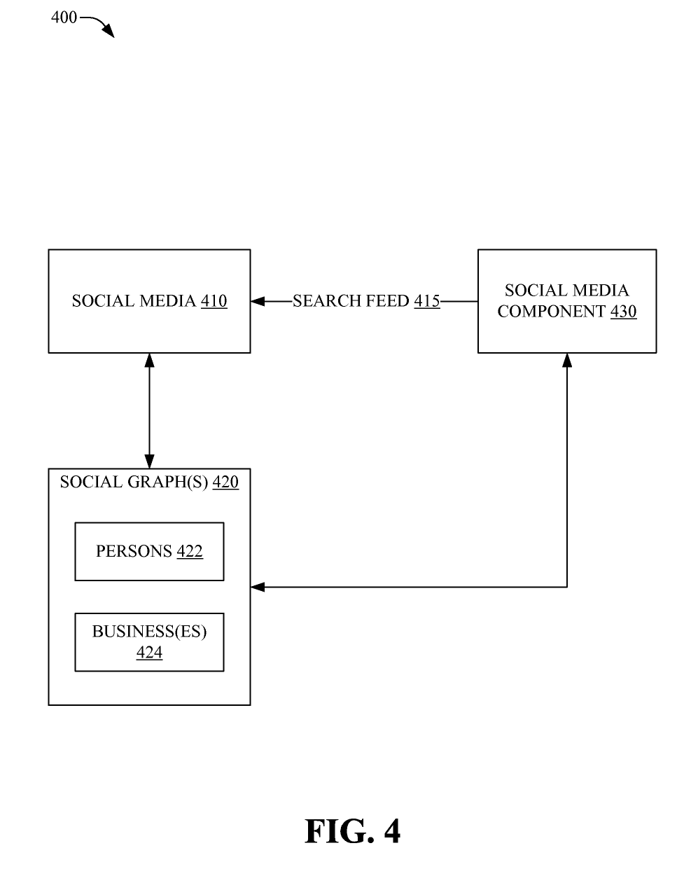

Now referring to FIG. 4, and in reference to the discussion related to FIG. 2 above, a block diagram illustrating creation of a search feed within a social networking environment 400 is illustrated, in accordance with an embodiment. As illustrated by FIG. 4, social media component 430 can transmit a search feed 415, e.g., transmit query 230, via social media 410 to one or more persons, businesses, organizations, etc. based on a query received by a person of persons 122—the query evaluated as a function of social graph(s) 120. In this way, social media component 430 can enable a real-time, dynamic dialogue between, for example, consumer(s), organization(s), and/or business(es) who are searching for products and/or services; and consumer(s), organization(s), and/or business(es) who are selling products and/or services—based on social graph(s) linking the consumer(s), organization(s), and/or business(es) within social network environment 400.

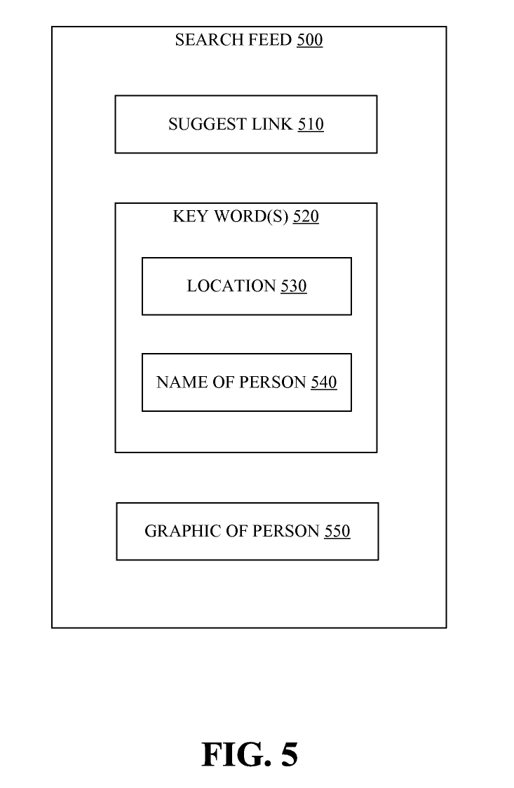

In one aspect illustrated by FIG. 5, a search feed 500, e.g., search feed 415, can include a suggest link 510 and one or more keywords 520 associated with a query, e.g., query 115, submitted by, e.g., a person of persons 122. Further, search feed 500 can include a graphical representation 550, e.g., drawing, photo, picture, etc. of the person. In an aspect, one or more keywords 520 associated with the query can include a location 530 associated with the query and a name 540 of the person who submitted the query. Activation of suggest link 510, e.g., via another person of persons 122, can initiate a response, e.g., see suggestion interface 720 below, to search feed 500.

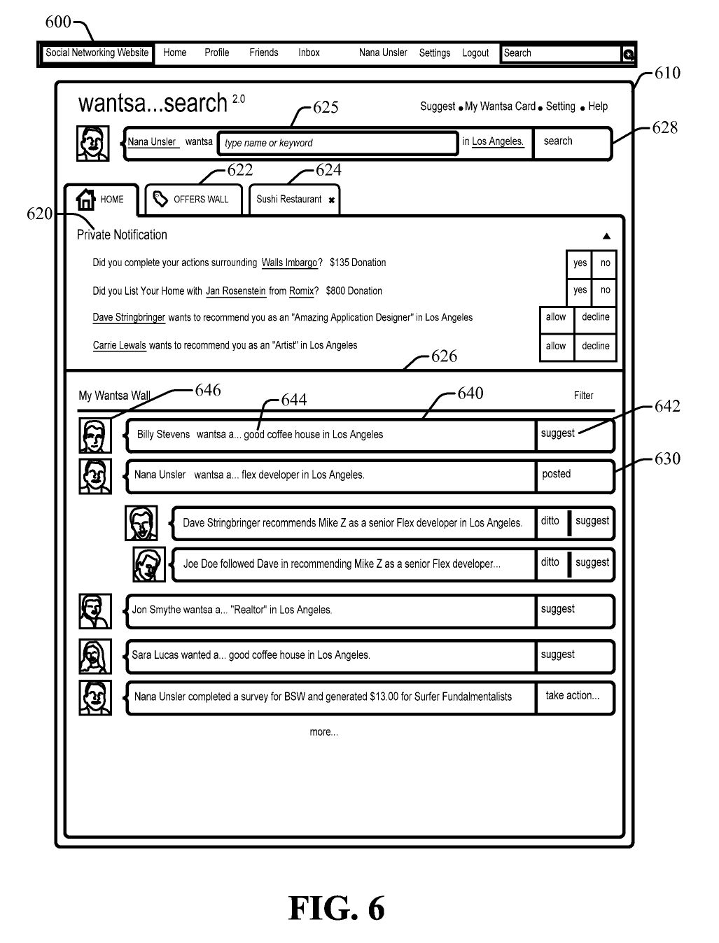

Referring now to FIG. 6, and in reference to the discussion related to FIGS. 1-2 and 4-5 (see above), a social media 610 associated with a social networking environment 600, e.g., social networking website, is illustrated, in accordance with an embodiment. Social media 610 can include one or more walls, e.g., private wall (see below) 620, offers wall (see below) 622, search results wall (see below) 624, and public wall 626. Public wall 626 includes communication feeds posted, e.g., via social media 610, by persons, e.g., persons 122, associated with social media 610. Further, social media 610 can include a query input area 625, in which social media component 130 can prompt the person of persons 122 to submit a query, e.g., query 115, by typing a name and/or keyword, e.g., one or more keywords 520, into query input area 625. In an aspect, query input area 625 can intelligently complete and/or suggest words, phrases, etc. to be entered into query input area 625 via social media component 130, as one or more characters associated with a query are typed into query input area 620 by the person.

Upon submission of the query, e.g., upon selection and/or activation by the person of search input 628, a wall feed 630 can be posted on public wall 626, e.g., via social media component 130. For example, as illustrated by FIG. 6, wall feed 630 was posted on public wall 626 via social media component 130 in response to a query submitted by Nana Unsler. In an aspect illustrated by FIG. 6, wall feed 630 is a local version of search feed 500 associated with the query submitted by Nana Unsler; although wall feed 630 does not include suggest link 510, it includes information, e.g., “posted”, indicating related search feeds 500 were disseminated and/or communicated to other persons associated with social media 610.

In another aspect illustrated by FIG. 6, a wall feed 640, e.g., search feed 500, was posted on public wall 626, e.g., via social media component 130, in response to a query, or search, submitted by Billy Stevens. Wall feed 640 can include suggest link 642, e.g., suggest link 510, and keyword(s) 644, e.g., one or more keywords 520, associated with the query submitted by Billy Stevens. Further, wall feed 640 can include graphical representation 646, e.g., graphical representation 550, which can be, for example, a drawing, photo, picture, etc. of the person, e.g., Billy Stevens. As described below, activation of suggest link 642, e.g., by Nana Unsler or another person of persons 122, can initiate a response to wall feed 640.

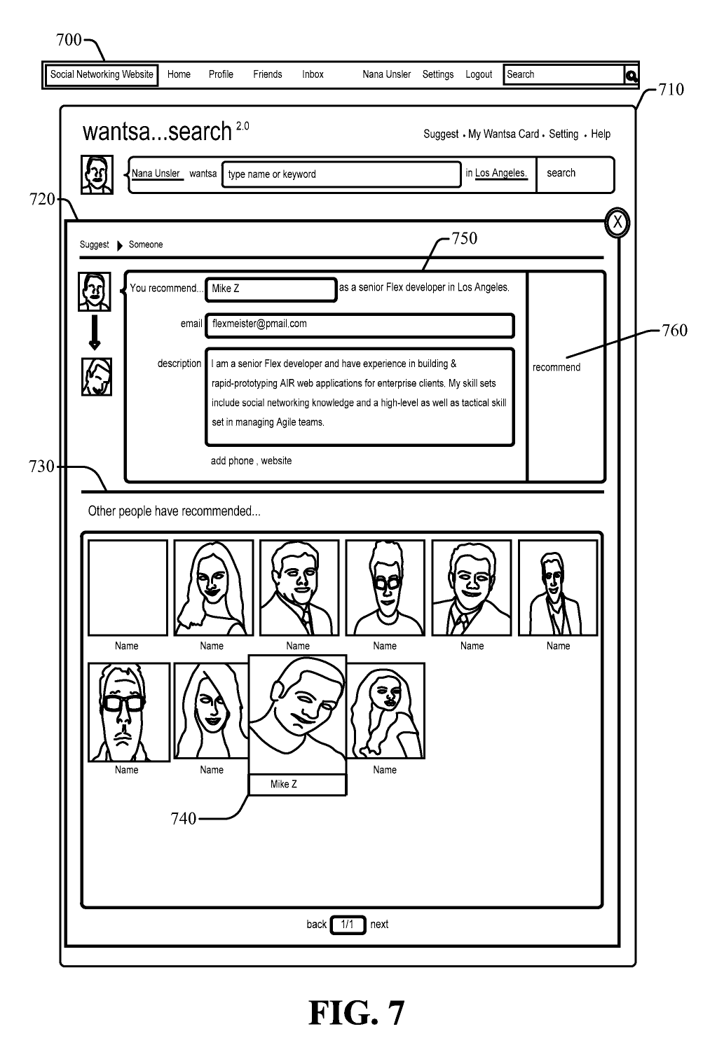

In an aspect illustrated by FIG. 7, social media component 130 can present a suggestion interface 720 upon activation of a suggest link, e.g., suggest link 510, suggest link 642, etc., in accordance with an embodiment. For example, social media component 130 can present suggestion interface 720 based on linking, matching, and/or relating one or more recommendation tags and/or keywords, e.g., related to one or more persons of persons 122 associated with social media 710, with keyword(s) 520, keyword(s) 644, etc. associated with a query submitted by a person of persons 122. As illustrated by FIG. 7, suggestion interface 720 is associated with a social media 710 of a social networking environment 700, e.g., social networking website. Suggestion interface 720 can include graphical element(s) 730 based on the one or more recommendation tags and/or keywords. Graphical element(s) 730 can include, e.g., photo(s), picture(s), drawing(s), symbol(s), etc. associated with name(s) of person(s), business(es), organization(s), etc. that the one or more persons have recommended via social media 710. In an aspect, the name(s) and associated recommendation tags and/or keywords can be stored in a data store, e.g., data store 350, for retrieval, e.g., by social media component 130.

Further, social media component 130 can be configured to emphasize, e.g., enlarge, highlight, etc. a graphical element (e.g., graphical element 740 of one or more graphical elements 730) associated with a recommendation corresponding to the query (see recommendation feed 800 below). Moreover, social media component 130 can include information 750 including, e.g., a name, email, telephone number(s), uniform resource locator (URL), etc. of a person, a business, an organization, etc. associated with the graphical element. Selection and/or activation of recommend link 760 by a person of persons 122 can trigger social media component 130 to create and disseminate (and/or communicate) a recommendation feed 800 (see below).

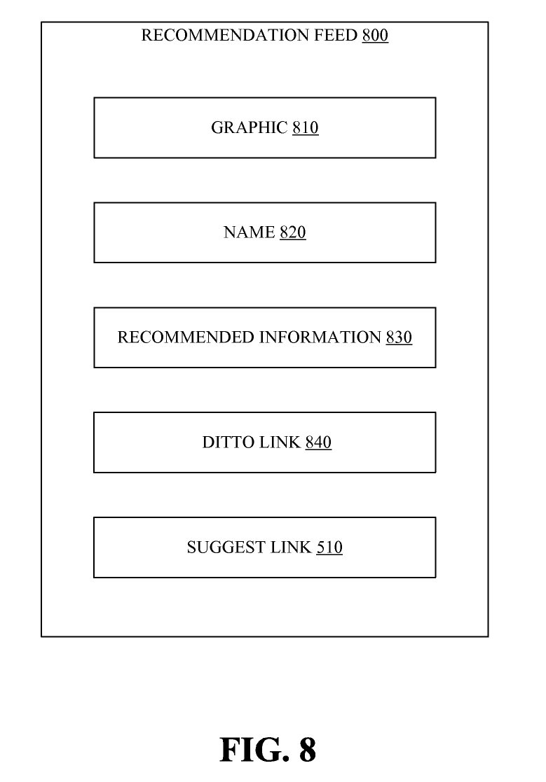

As described above, social media component 130 can determine whether at least one person, business, organization, advertiser, etc. submitted a response, e.g., response(s) 210, to query 115. In one aspect, response(s) 210 can include recommendation feed 800, illustrated by FIG. 8. Recommendation feed 800 can be created and disseminated via a social media, e.g., social media 110, 310, 410, 610, 710, etc. based on a person's recommendation of a product, a business, etc. via selection and/or activation of recommend link 760. As illustrated by FIG. 8, recommendation feed 800 can include graphic 810 and name 820, which correspond to a name of the person who selected and/or activated recommend link 760 and a graphical element, e.g., photograph, picture, drawing, etc. associated with the person, respectively. Further, recommendation feed can include recommended information 830, e.g., including a name of a person, business, organization, etc. recommended via recommend link 760 and a description of product(s) and/or service(s) associated with the name.

As illustrated by FIG. 8, recommendation feed 800 can further include suggest link 510 and ditto link 840. As described above, social media component 130 can present suggestion interface 720 upon activation of suggest link 510. Further, social media component 130 can create another recommendation feed 800 based on a single activation of ditto link 840. For example, when a person of persons 122 (1) views that an other person recommended a product and/or service, via a first recommendation feed 800, and (2) wants to post another recommendation that concurs with the first recommendation feed 800, the person can simply activate ditto link 840 via a “one-click” activation of ditto link 840, e.g., utilizing an input device associated with a personal computer and/or a mobile wireless communication device displaying, for example, social media 110, 310, 410, 610, 710, etc. Based on the one-click activation of ditto link 840, social media component 130 can create and post a second recommendation feed 800 indicating the person concurs with the first recommendation feed 800. It should be appreciated that more than two recommendation feeds 800 can be created based on one-click activations of ditto link 840. As such, social media component 130 can enable persons of persons 122 to recommend the same product and/or service in a “viral” manner within social networking environment(s).

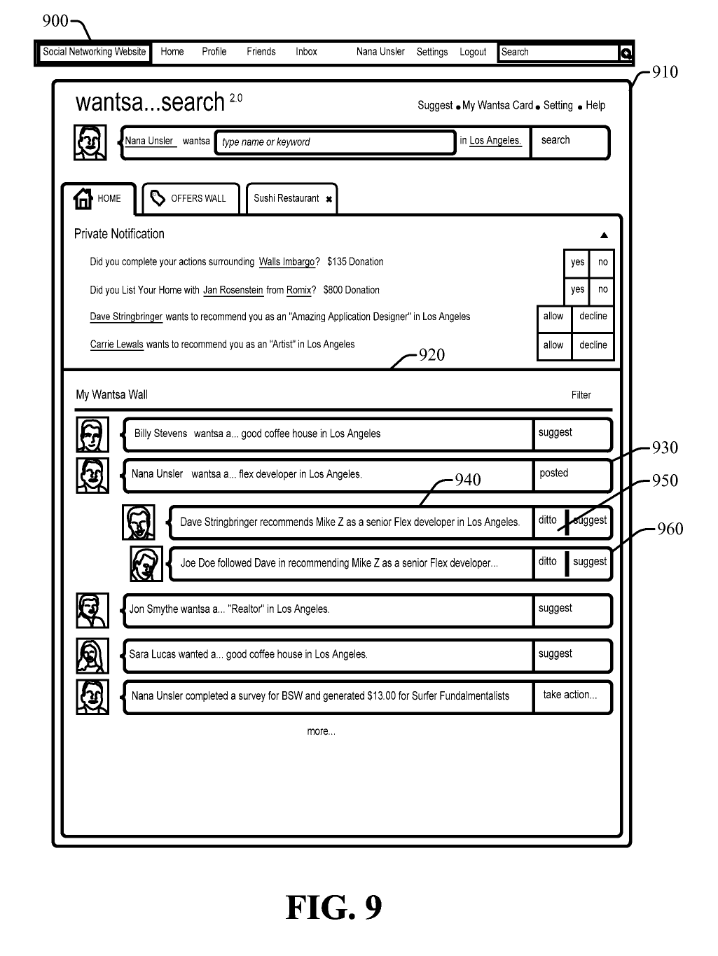

For example, FIG. 9 illustrates a social networking environment 900 including two recommendation feeds 800, e.g., wall feeds 940 and 960, posted on pubic wall 920 of social media 910, e.g., via social media component 130, in accordance with an embodiment. Wall feed 930 corresponds to a query, e.g., query 115, submitted by Nana Unsler. As illustrated by FIG. 9, Nana Unsler seeks a flex developer in Los Angeles. Wall feed 940 is a recommendation feed 800 posted on public wall 920 in response to a selection and/or activation of recommend link 760 (see above) by Dave Stringbringer. For example, recommend link 760 can be displayed in a public wall associated with Dave Stringbringer via suggestion interface 720 based on an activation by Dave Stringbringer of a suggest link, e.g., suggest link 510, associated with the query submitted by Nana Unsler. As illustrated by FIG. 9, Dave Stringbringer recommended Mike Z via wall feed 940.

On the other hand, wall feed 960 is a recommendation feed 800 posted on wall 920 in response to a one-click selection and/or activation by Joe Doe of ditto link 950. As illustrated by FIG. 9, social media component 130 created and posted wall feed 960 indicating Joe Doe followed, or concurred with, Dave Stringbringer's recommendation of Mize Z. As such, social media component 130 enabled Joe Doe to recommend Mize Z based on a one-click activation of ditto link 950.

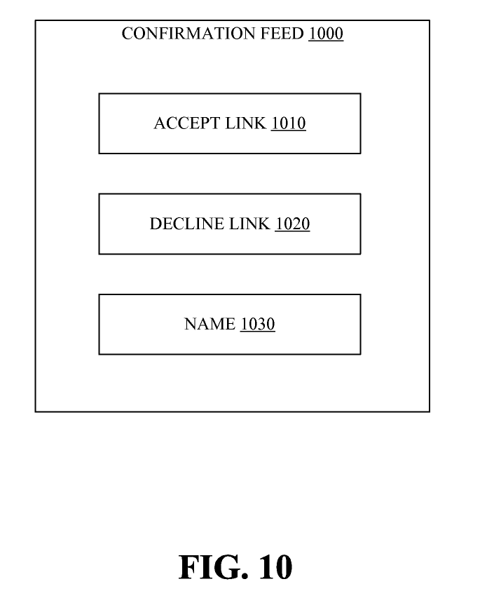

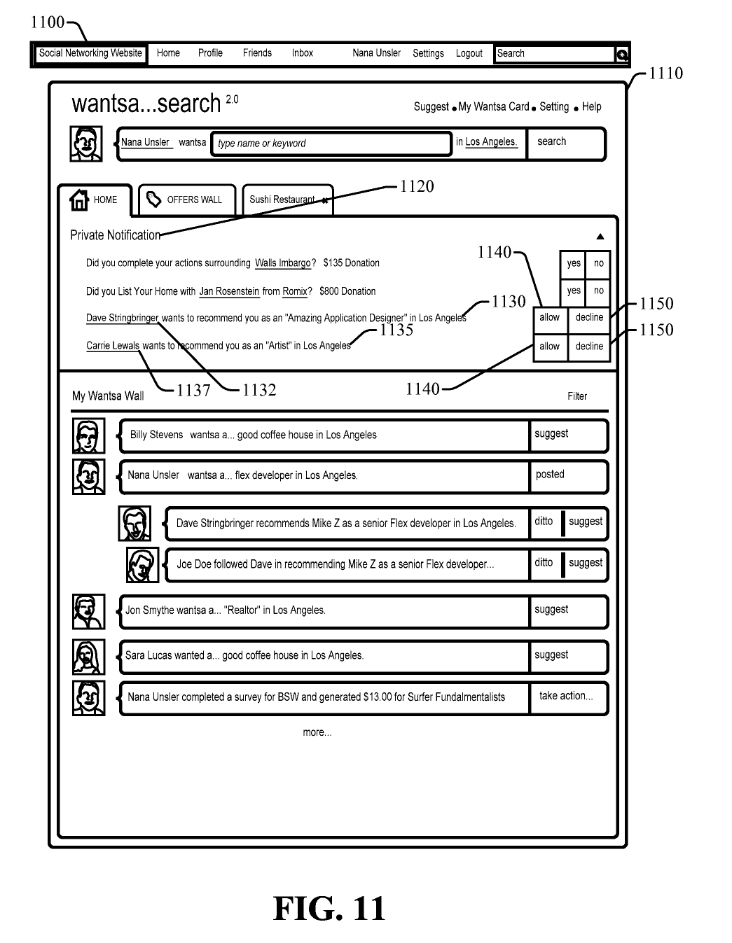

Referring now to FIGS. 10 and 11, and in reference to the discussion related to FIGS. 2, 5, and 8 (see above), social media component 130 can generate a confirmation feed 1000 based on activation of suggest link 510 by a person of persons 122. Confirmation feed 1000 can include an accept link 1010, a decline link 1020, and name 1030 of the person, e.g., recommender, who activated suggest link 510 in response to a query, e.g., query 115. Social media component 130 can transmit, e.g., via suggestion interface 720, confirmation feed 1000 to a person, business, and/or organization recommended by the recommender in a private wall, e.g., private wall 1120, private wall 620, etc. of the person, business, and/or organization. The private wall can receive private postings, e.g., directed to a person associated with social media 110, which require action(s) by the person. For example, such actions can relate to confirmation feed 1000 and/or a verification feed (see below).

Further, social media component 130 can receive an accept activation of accept link 1010 or a decline activation of decline link 1020 from the recommended person, business, and/or organization. When the recommended person, business, and/or organization initiates an accept activation, via accept link 1010, social media component 130 can disseminate recommendation feed 800 via social media 110, 310, 410, 610, 710, 910, 1110, etc. to persons of persons 122. On the other hand, when the recommended person, business, and/or organization initiates a decline activation, via decline link 1020, social media component 130 can send a decline message to the recommender, e.g., via private wall 1120 (see below).

For example, FIG. 11 illustrates a social networking environment 1100 including two confirmation feeds, 1130 and 1135, posted on private wall 1120 of social media 1110, e.g., via social media component 130, in accordance with an embodiment. As illustrated by FIG. 11, confirmation feeds 1130 and 1135 were disseminated and/or communicated to Nana Unsler based on recommendations made by Dave Stringbringer, e.g., name 1132, and Carrie Lewals, e.g., name 1137, respectively. As illustrated, Nana Unsler can initiate an accept activation or decline activation of confirmation feeds 1130 and 1135, e.g., via accept link 1140 and decline link 1150, respectively.

In another aspect (not shown), social media component 130 can enable the recommended person to decline a recommendation based on a recommendation tag associated with the recommendation, but create a preferable recommendation tag. The preferable recommendation tag can then be sent to the recommender for acceptance, e.g., to a private wall of the recommender, via social media component 130. For example, a message can be sent to the recommender indicating “[the recommended person] did not accept your tag as a ‘designer’, but suggests a tag of ‘interior designer’. Do you recommend [the recommended person] based on this tag?” Accordingly, the recommender can accept or decline the preferable recommendation tag.

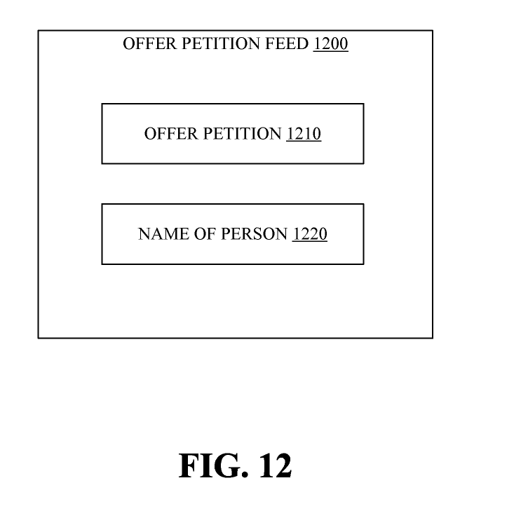

Now referring to FIG. 12, an offer petition feed 1200 is illustrated, in accordance with an embodiment. In reference to the discussion related to FIGS. 1 and 2 above, social media component 130 can send a message via social media 110 to a person who submitted query 115 when no response was submitted to the query, for example, stating that no offers and/or recommendations were received, e.g., via social networking environment 200. Further, the message can request the person suggest an offer petition, or request, to be posted via social media 110. Accordingly, social media 110 can receive information from the person, and create offer petition feed 1200 based on the information. Further, social media component 130 can send offer petition feed 1200 via social media 110 to other person(s) of persons 122 and/or business(es) of business(es) 124, e.g., to facilitate offer(s) to be submitted by the other person(s) and/or business(es). In another aspect, social media component 130 can send offer petition feed 1200 to person(s), business(es), organization(s), and/or advertiser(s) associated with, e.g., social media 110, 310, 410, 610, 710, 910, 1110, etc. In an aspect, offer petition feed 1200 can include offer petition 1210 and a name 1220 of the person seeking offer(s) via, e.g., social media 110, 310, 410, 610, 710, 910, 1110, etc.

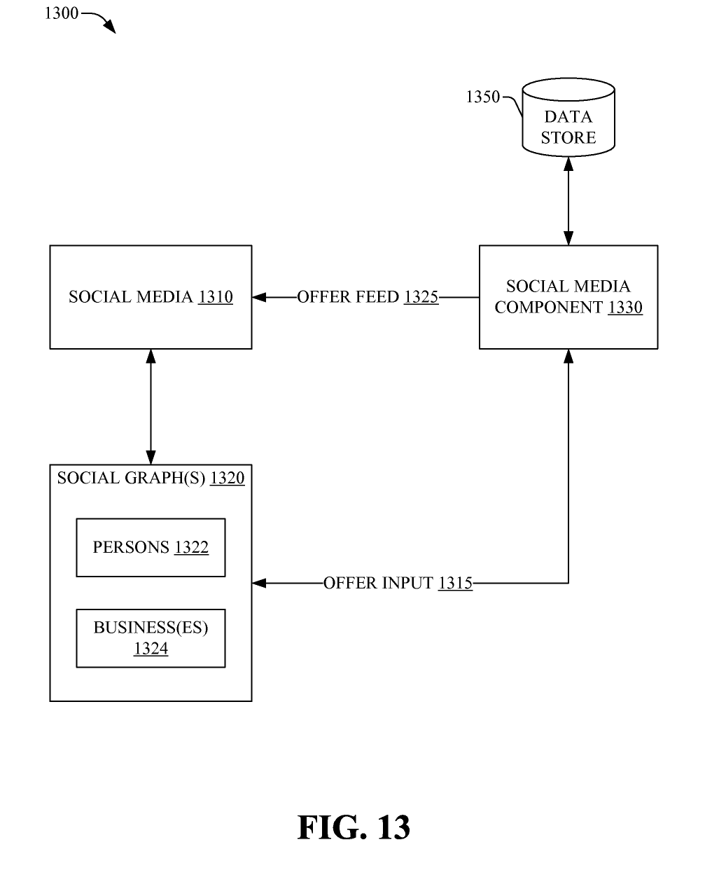

FIG. 13 illustrates creating an offer feed 1325, e.g., interactive communication 220 and/or interactive communication 345, within a social networking environment 1300, in accordance with an embodiment. As illustrated by FIG. 13, social media component 1330 can receive an offer input 1315 from a person, e.g., of persons 1322, and/or a business, e.g., of business(es) 1324, in response to a query, e.g., query 115, query 315, etc. For example, a member of a Facebook™ community can post to all other members of the Facebook™ community an offer related to selling the member's couch. In another example, a non-profit organization can post an offer to member(s) of the Facebook™ community to entice such member(s) to become members of the non-profit organization and/or to solicit donations from member(s) of the Facebook™ community. In yet another aspect, social media component 1330 can create an offer feed 1325 based on, at least in part, offer input 1315 and social graph(s) 1320. Further, social media component 1330 can send offer feed 1325 to persons 1322 via social media 1310. Moreover, other information associated with offer feed 1325 can be stored in data store 1350, enabling future queries to be evaluated based on, at least in part, the other information.

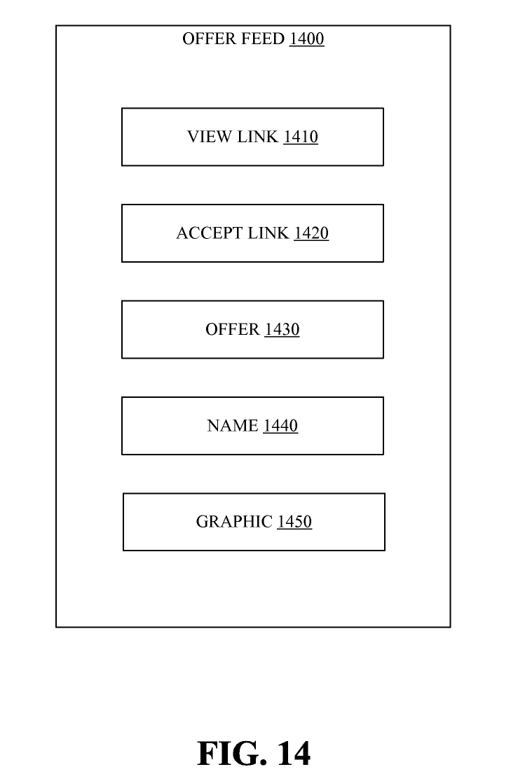

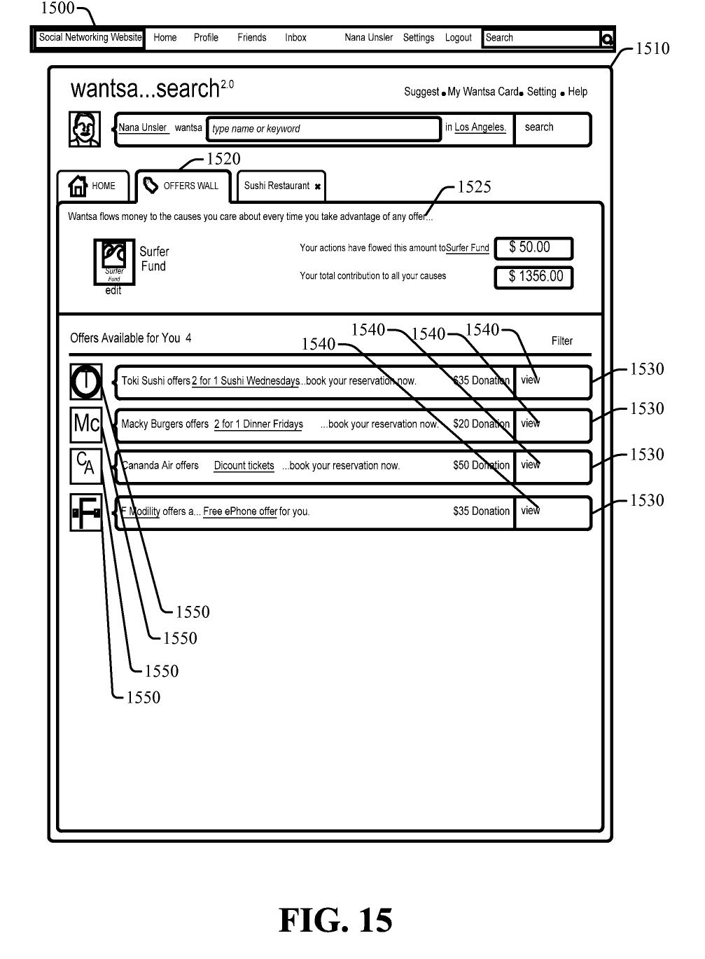

For example, FIGS. 14 and 15 illustrate an offer feed 1400 and offer feeds 1530, respectively, in accordance with an embodiment. Offer feed 1400 can include a view link 1410, an accept link 1420, and an offer 1430. In another aspect, offer feed 1400 can include a name 1440 of a person, e.g., of persons 1322, an organization, an advertiser, or a business, e.g., of business(s) 1324, who submitted offer feed 1400; and a graphical representation 1450, e.g., photo, drawing, etc. of the person, organization, advertiser, or business. In yet another aspect, offer feed 1400 can include an image and/or representation (not shown) of a product or service associated with offer 1430. In one aspect, offer feed 1400 can include a multimedia file and/or content (not shown), e.g., audio file, video file, picture, etc. that can be presented via a social media, e.g., via social media 1310, for example, when a person, organization, advertiser, and/or business engages, e.g., selects, offer feed 1400 via the social media. FIG. 15 illustrates offer feeds 1530 can be displayed via offers wall 1520 of social media 1510, e.g., via social media component 1330, within social networking website 1500. As illustrated, each offer feed 1530 includes a view link 1540 and a graph representation 1550. In another aspect, offer feeds 1530 can also be displayed via a public wall, e.g., public wall 626 (not shown). Further, a percentage of advertising revenue (1) generated when an offer feed 1400, e.g., offer feed 1530, is accepted by a person associated with offers wall 1520, e.g., Nana Unsler, can be (2) donated to a cause and/or a charity selected the person—the cause and/or charity displayed in cause section 1525 of offers wall 1520.

Returning now to FIG. 14, in yet another aspect, offer 1430 can be an offer of at least one of an incentive, a discount, a benefit, or compensation in exchange for an action, a product, and/or a service. In one aspect, offer information (not shown) of the offer can be displayed via social media 1310 to the person, organization, advertiser, or business based on a view activation of view link 1410, e.g., by a person activating view link 1410 via a user interface coupled to social media 1310. In another aspect, the action can include, at least in part, an accept activation of accept link 1420, e.g., by a person of persons 1322 activating accept link 1420 via a user interface coupled to social media 1310 to accept offer 1430.

In yet another aspect, when a person, e.g., of persons 1322, engages with offer 1430 via accept link 1420, an action feed (see below) can be automatically generated and communicated (and/or disseminated) to wall(s) associated with person(s) 1324. As such, when the person engages with offer 1430 via accept link 1420, other person(s) of persons(s) 1324 can be notified. Further, the other person(s) can be informed of results associated with the action. Moreover, the action feed can be actionable for the other person(s), e.g., enabling the other person(s) to perform the action in exchange for the at least one of the incentive, the discount, the benefit, or the compensation—proliferating a viral loop of ongoing feeds and actions surrounding each action feed.

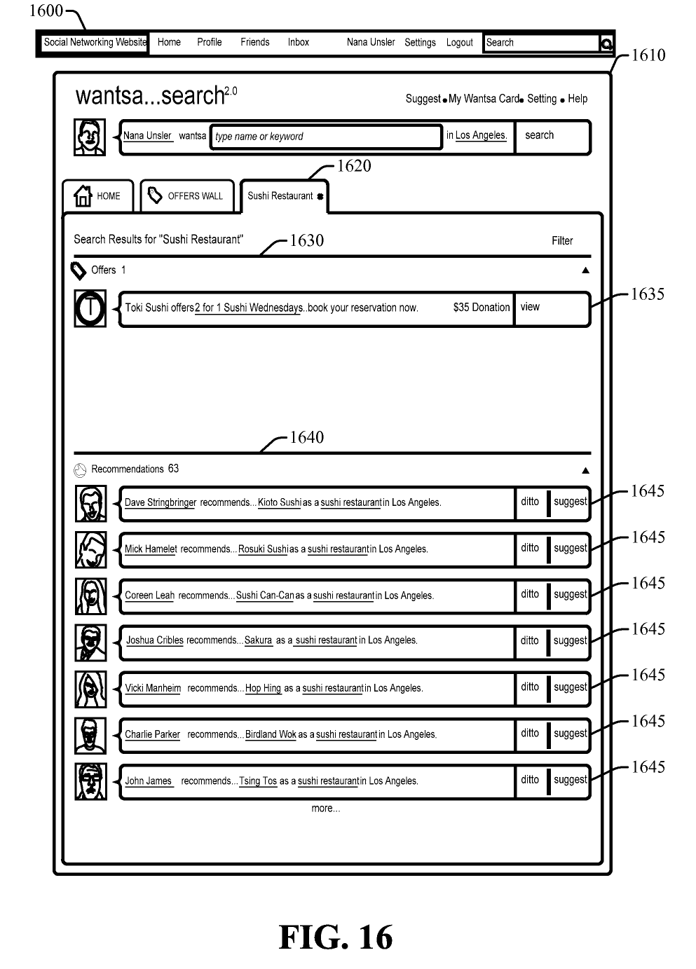

FIG. 16 illustrates a search results wall 1620, in accordance with an embodiment. Search results wall 1620 is included in social media 1610, which is associated with a social networking environment 1600, e.g., social networking website. Further, search results wall 1620 includes offers area 1630 and recommendations area 1640. Offers area 1630 can include offer feeds 1635, e.g., offer feeds 1400, submitted, e.g., via social media component 130, by person(s), e.g., of persons 122, and/or business(es), e.g., of business(es) 124, in response to a query, e.g., search for a sushi restaurant in Los Angeles submitted by Nana Unsler. Moreover, recommendations area 1640 can include recommendation feeds 1645, e.g., recommendation feeds 800, submitted, e.g., via social media component 130, by person(s) of persons 122 responding to the query.

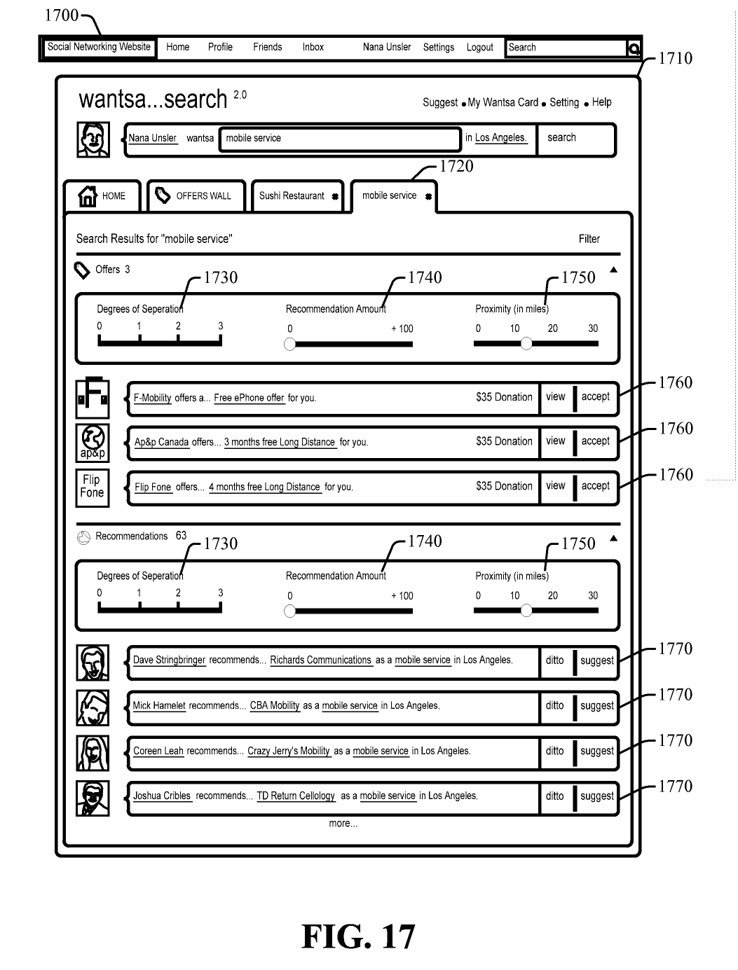

In one aspect, recommendation feeds 1645 can be ordered within recommendations area 1640 based on a degree of separation between a person who submitted a query, e.g., Nana Unsler, and the person(s) who submitted recommendation feeds 1645 in response to the query. Further, offer feeds 1635 can be ordered within offers area 1630 based on a degree of separation between the person who submitted the query and person(s), business(es), organization(s), and/or advertiser(s) who submitted offer feeds 1635. In another aspect, offer feeds 1635 and/or recommendations feeds 1645 can be ordered based on a recommendation amount and/or an offer amount, and/or a proximity, e.g., in miles, from a location of the person who submitted the query and location(s) of person(s), business(es), organization(s), and/or advertiser(s) submitting offers and/or recommendations. For example, in social networking environment 1700, illustrated by FIG. 17, social media 1710 of social networking website 1700 can include search results wall 1720, e.g., related to a query for mobile phone service submitted by Nana Unsler. As illustrated, social media 1710 enables sorting offers 1760 and recommendations 1770 based on degrees of separation 1730, recommendation/offer amounts 1740, and/or proximity 1750 between a location of the person who submitted the query, e.g., Nana Unsler, and locations(s) of person(s), business(es), organization(s), advertiser(s), etc. who submitted offers 1760 and recommendations 1770.

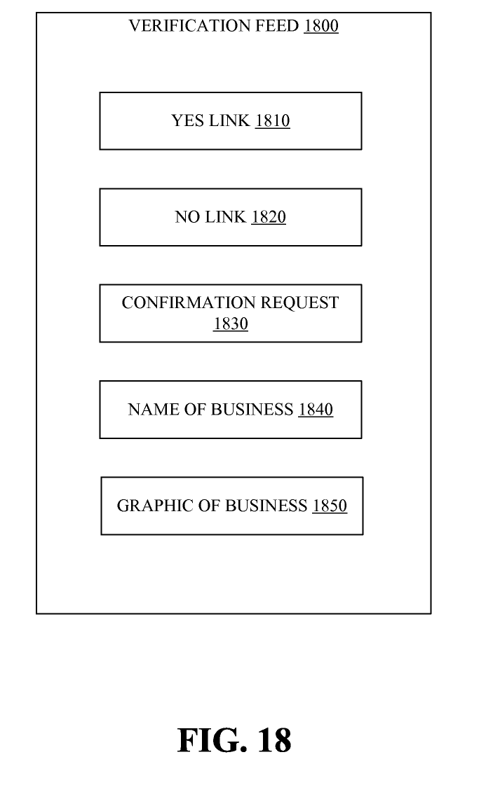

FIG. 18 illustrates a verification feed 1800, in accordance with an embodiment. In reference to the discussion related to FIG. 14 above, social media component 1330 can transmit a verification feed 1800 via social media 1310 to a person of person(s) 1322 associated with an accept activation of accept link 1420. Verification feed 1800 can include a yes link 1810, a no link 1820, and a confirmation request 1830 for the person to confirm whether an action associated with offer 1430 was completed. Further, verification feed 1800 can include a name of a business 1840 associated with offer 1430 and a graphical representation 1850 of the business. Social media component 1330 can send a confirmation message (not shown) to the business based on, at least in part, a yes link activation of yes link 1810 by the person. In one aspect, the confirmation message can inform the business that the action related to offer 1430 was completed. Upon a reject link activation of no link 1820 by the person, social media component 1330 can prompt the person to cancel the action or submit another response; and/or social media component 1330 can record the reject link activation in data store 1350 for later retrieval, analysis, e.g., by the business.

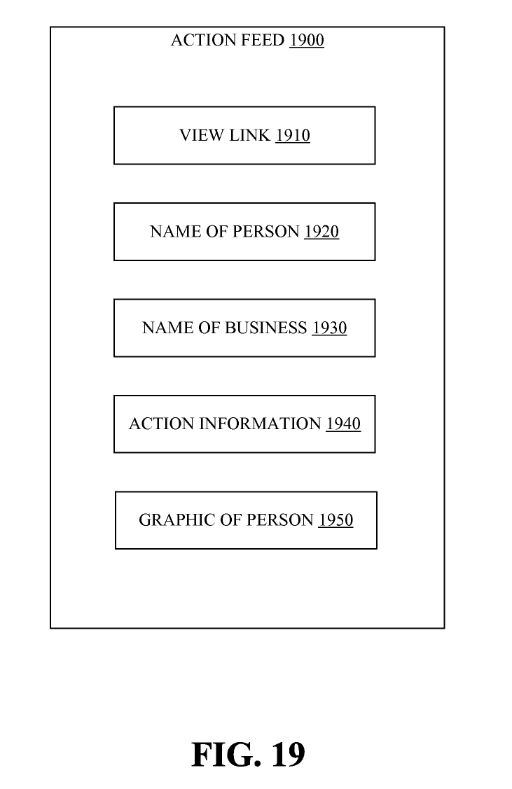

FIG. 19 illustrates an action feed 1900, in accordance with an embodiment. As described above, when a person, e.g., of persons 1322, engages with and accepts offer 1430 via accept link 1420, an action feed can be automatically generated and communicated (and/or disseminated) to wall(s) associated with person(s) 1322. In reference to the discussion related to FIGS. 13 and 14 above, social media component 1330 can transmit action feed 1900 via social media 1310 to person(s) 1322 based on, at least in part, an accept activation, e.g., related to offer feed 1325, offer feed 1400, etc. Action feed 1900 can include view link 1910 from which person(s) 1322 can view information about the action, e.g., name of person 1920 who completed the action, name of business 1930 associated with the action, action information 1940, and a graphical representation 1950 of person 1920—e.g. via a view link activation of view link 1910. Further, offer information (not shown), e.g. regarding offer 1430, can be displayed via social media 1310 based on the view link activation. In this way, businesses can benefit via social media component 1330 as activity of persons 1322 associated with a social networking environment, e.g., social networking environment 1300, can be viewed by all persons associated with social graph(s) 1320—enticing other persons to partake in, or not miss out on, “good deals” (offers) that their friends accepted via social media 1310.

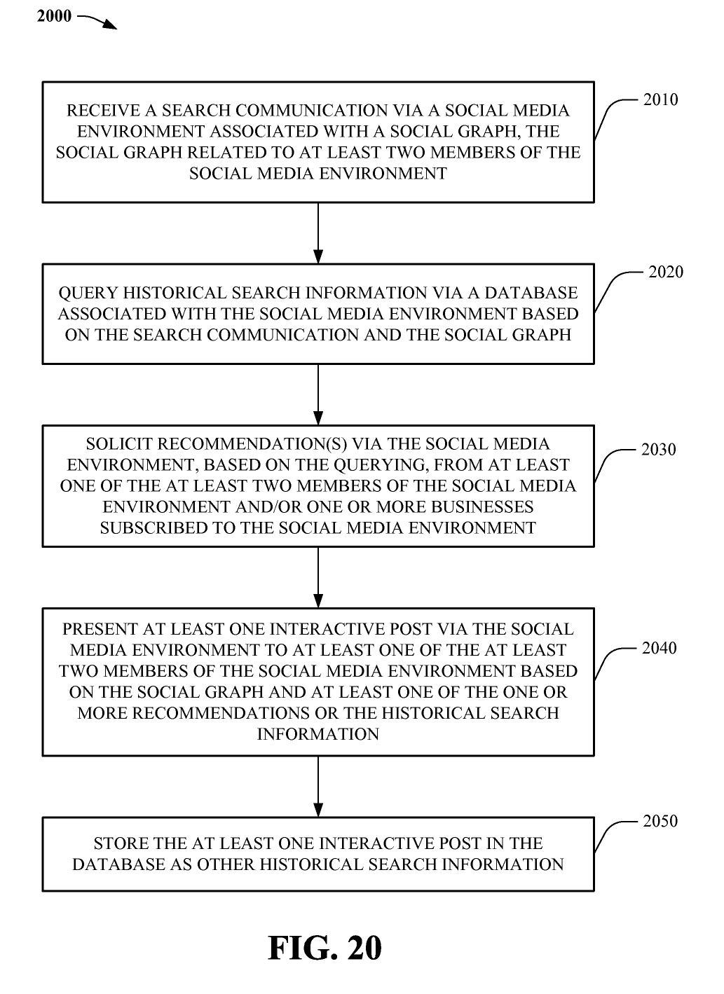

FIGS. 20-30 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 20, a process 2000 for feed-based communication via a social network environment based on one or more social graphs associated with the social network environment is illustrated, in accordance with an embodiment. At 2010, a search communication can be received via a social media environment associated with one or more social graphs—the one or more social graphs related to at least two members of the social media environment. For example, the search communication can include at least one of: (1) a search feed submitted by a first member of the at least two members for broadcast via the social media environment, the search feed including a query for at least one of a product or a service; (2) a recommendation feed submitted by a second member of the at least two members for broadcast via the social media environment based on the search feed, wherein the recommendation feed includes a recommendation of a member of the at least two members, wherein the recommendation feed includes a ditto link that, when activated by a third member of the at least two members, creates an interactive post of the at least one interactive post agreeing with the recommendation feed, and wherein the interactive post includes a name of the third member; (3) a confirmation feed for broadcast to the member via the social media environment, the confirmation feed including a request for acceptance of the recommendation feed by the member; (4) an offer feed submitted by a business of the one or more businesses subscribed to the social media environment for broadcast to the first member via the social media environment based on the search feed, the offer feed including an offer of at least one of an incentive, a discount, a benefit, or compensation in exchange for an action performed by the first member; (5) a verification feed for broadcast to the first member via the social media environment, the verification feed including a request for the first member to confirm whether the action was performed; (6) an action feed for broadcast via the social media environment including information associated with the action performed by the first member; (7) an offer petition feed submitted by a fourth member of the at least two members of the social media environment for broadcast via the social media environment, the offer petition feed including a petition for the offer feed; (8) a group offer petition feed submitted by a fifth member of the at least two members of the social media environment for broadcast via the social media environment, the group offer petition feed inviting other members of the at least two members to send a group petition for the offer feed; or (9) a share offer feed submitted by a sixth member of the at least two members of the social media environment for broadcast via the social media environment, the share offer feed including the offer feed.

In another example, the search communication can include at least one of: a social network community feed, an interactive news feed, a short message service (SMS) feed, a multimedia messaging service (MMS) feed, an instant messaging (IM) feed, a rich site summary (RSS) feed, or an extensible markup language (XML) feed.

Historical search information can be queried at 2020 via a database associated with the social media environment based on the search communication and the one or more social graphs. At 2030, one or more recommendations can be solicited via the social media environment, based on the querying, from at least one of: one of the at least two members of the social media environment or one or more businesses subscribed to the social media environment. In an aspect, one or more recommendations can be solicited via the social media environment via at least one of an SMS message, an MMS message, an email message, a Facebook™ message, etc. At least one interactive post can be presented via the social media environment, at 2040, to the at least two members of the social media environment based on the one or more social graphs and at least one of the one or more recommendations or the historical search information. Further, at 2150, the at least one interactive post can be stored in the database as other historical search information, e.g., to be utilized for further search communications.

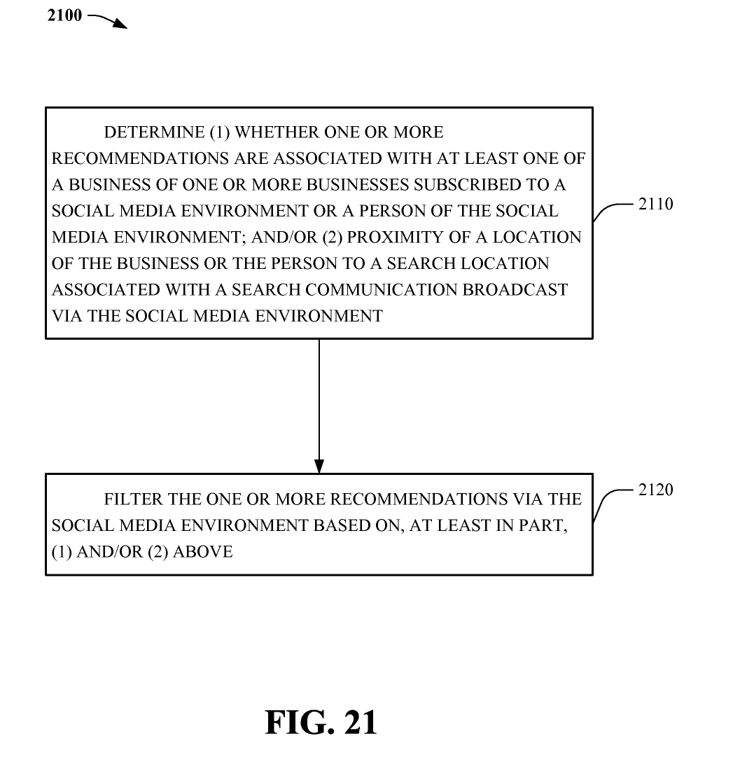

FIG. 21 illustrates another process (2100) for feed-based communication via a social network environment based on one or more social graphs associated with the social network environment, in accordance with an embodiment. At 2110, process 2100 can determine: (1) whether one or more recommendations are associated with at least one of a business of one or more businesses subscribed to a social media environment or a person related to the social media environment; and/or (2) proximity of a location of the business or the person to a search location associated with a search communication. At 2120, the one or more recommendations can be filtered via the social media environment based on, at least in part, step 2110.

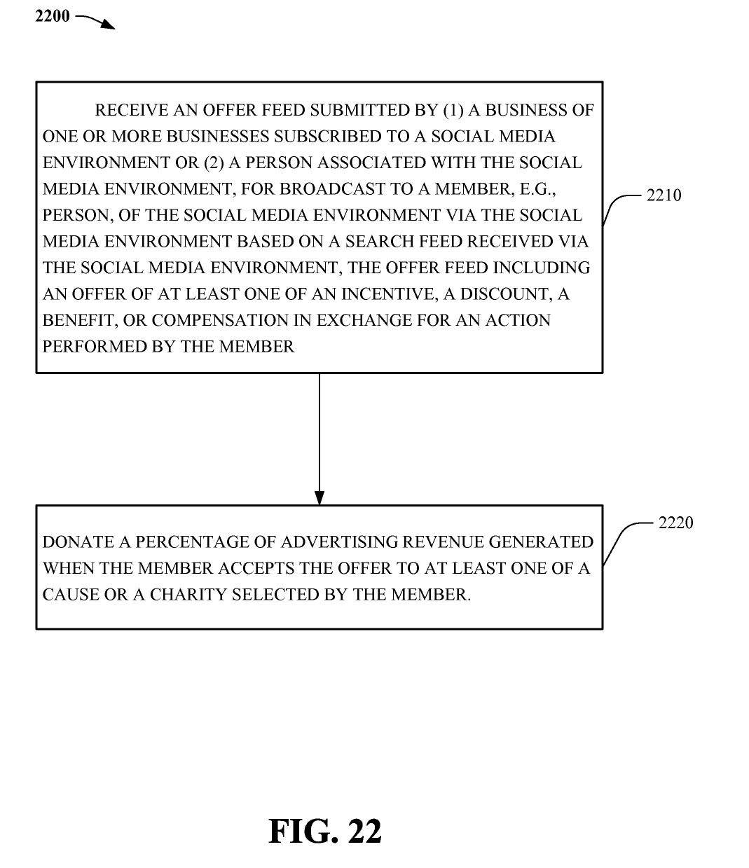

FIG. 22 illustrates yet another process (2200) for feed-based communication via a social network environment based on one or more social graphs associated with the social network environment, in accordance with an embodiment. At 2210, an offer feed submitted by (1) a business of one or more businesses subscribed to a social media environment or (2) a person associated with social media environment can be received by a member, or person, of the social media environment via the social media environment based on a search feed received via the social media environment, the offer feed including an offer of at least one of an incentive, a discount, a benefit, or compensation in exchange for an action performed by the member. For example the offer can include: a purchase offer associated with selling a product or a service; a complete form offer associated with completing a form; a survey offer associated with completing a survey; a poll offer associated with completing a poll; a coupon offer associated with receiving at least one of the product or the service; a branding offer associated with advertising via the social media environment; and/or a classified offer associated with agreeing to be associated with a person who posted the classified offer or a business who posted the classified offer.

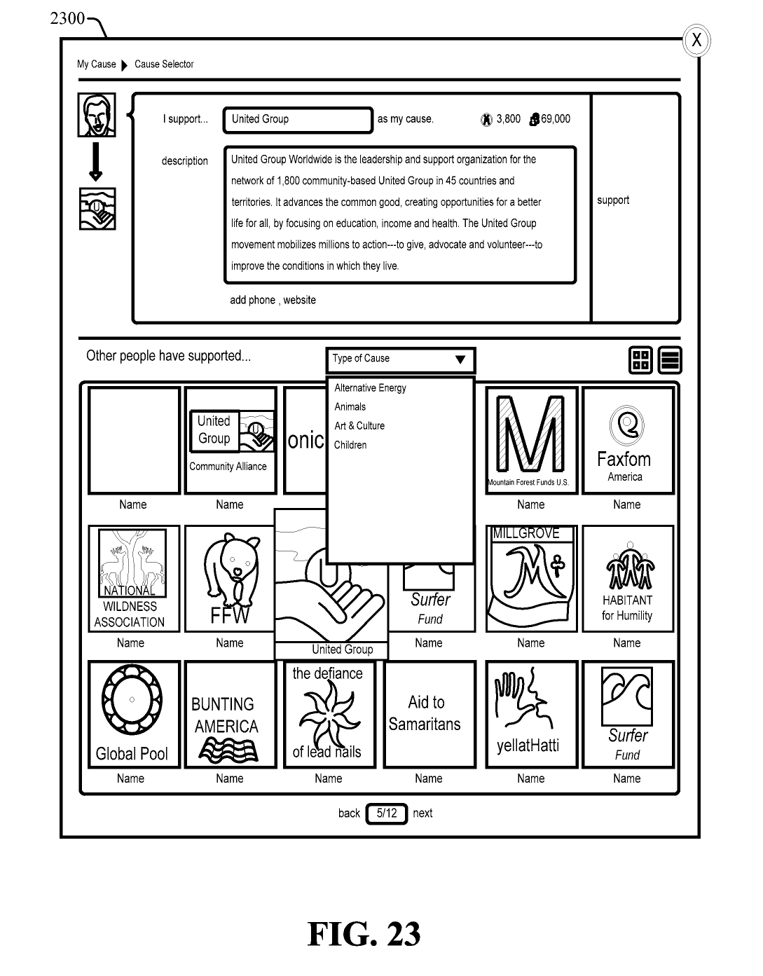

In an aspect, a percentage of advertising revenue generated when a person accepts the offer can be donated at 2220 to at least one of a cause or a charity selected by the member. For example, FIG. 23 illustrates a cause selection view 2300 associated with a social media (not shown), in accordance with an embodiment. In an aspect, cause selection view 2300 can enable the member to select a cause from causes 2310 that persons associated with the social media have recommended, e.g., the cause and/or charity displayed in cause section 1525 of offers wall 1520.

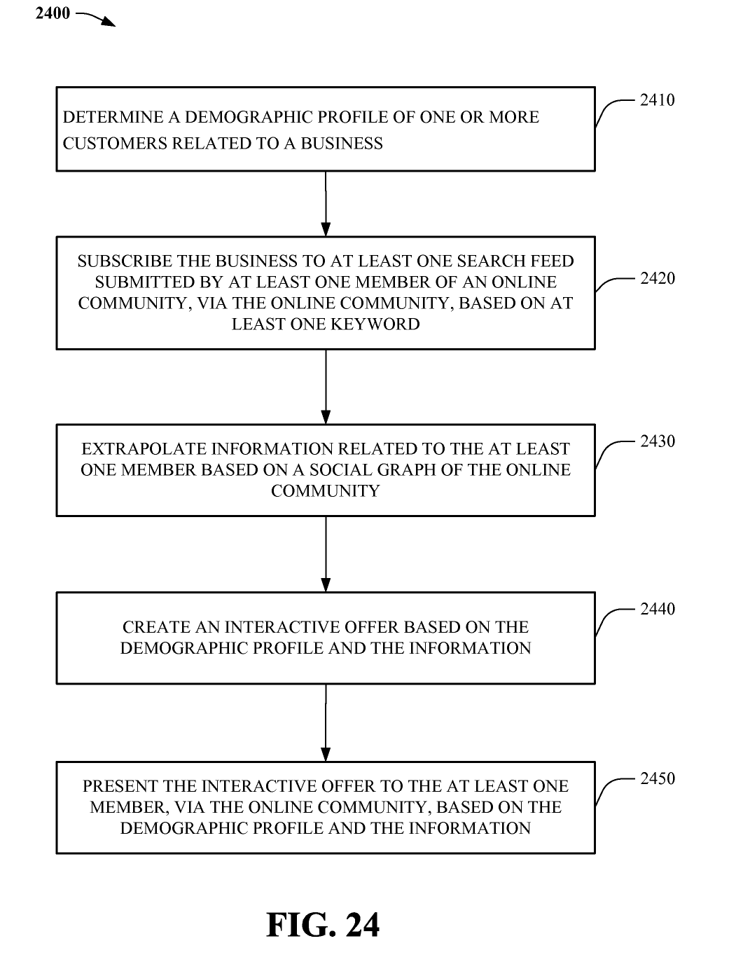

FIG. 24 illustrates a process 2400 related to business(es) presenting offers within a social network environment based on one or more social graphs associated with the social network environment, in accordance with an embodiment. At 2410, a demographic profile of one or more customers related to a business can be determined. At 2420, the business can be subscribed to at least one search feed submitted by at least one member of an online community, via the online community, based on at least one keyword. Information related to the at least one member can be extrapolated at 2430 based on one or more social graphs of the online community. At 2440, an interactive offer can be created based on the demographic profile and the information. The interactive offer can be presented at 2450 to the at least one member, via the online community, based on the demographic profile and the information.

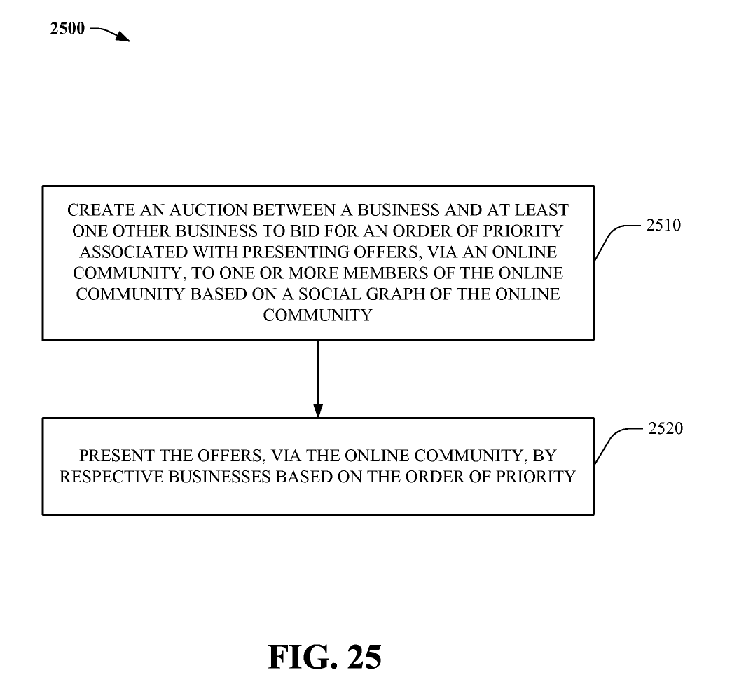

FIG. 25 illustrates a process 2500 for auctioning presentation of offers within a social network environment based on one or more social graphs associated with the social network environment, in accordance with an embodiment. At 2510, an auction between a business and at least one other business to bid for an order of priority associated with presenting offers, via the online community, to one or more members of the online community can be created based on one or more social graphs of the online community. The offers can be presented at 2520, via the online community, by respective businesses based on the order of priority.

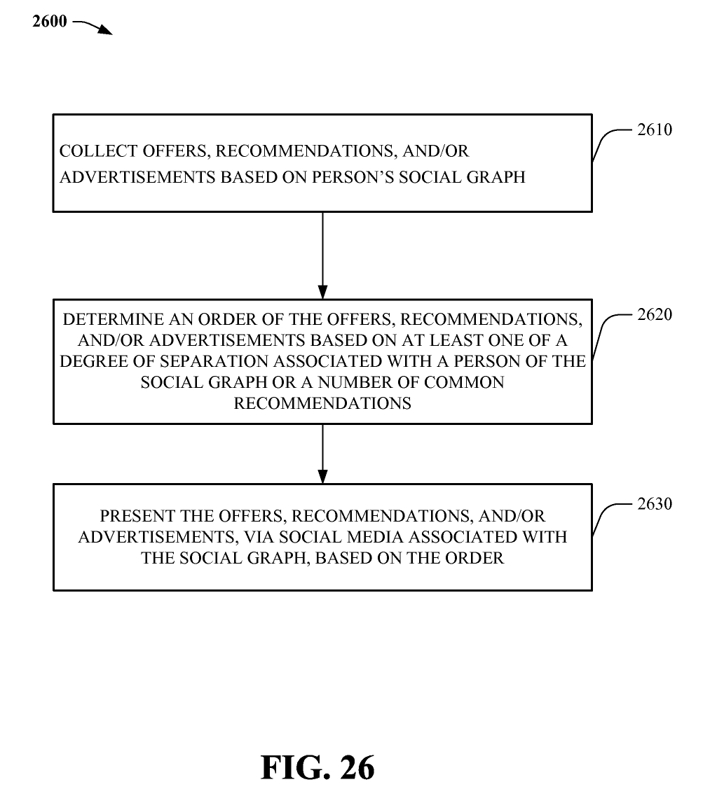

FIG. 26 illustrates a process 2600 for ordering offers, recommendations, and/or advertisements based on one or more social graphs, in accordance with an embodiment. At 2610, offers, recommendations, and/or advertisements can be collected from person(s) and/or business(es) associated with one or more social graphs of a user in response to a search feed submitted by the user. At 2620, the offers, recommendations, and/or advertisements can be ordered based on popularity, e.g., degree of separation, associated with the one or more social graphs. In another aspect, the offers, recommendations, and/or advertisements can be ordered based on a number of common recommendations. At 2630, the offers, recommendations, and/or advertisements can be presented to the user, via a social media related to the one or more social graphs, based on the order determined at 2620. In this way, the order of offers can be customarily displayed with the highest possible level of relevance to the user.

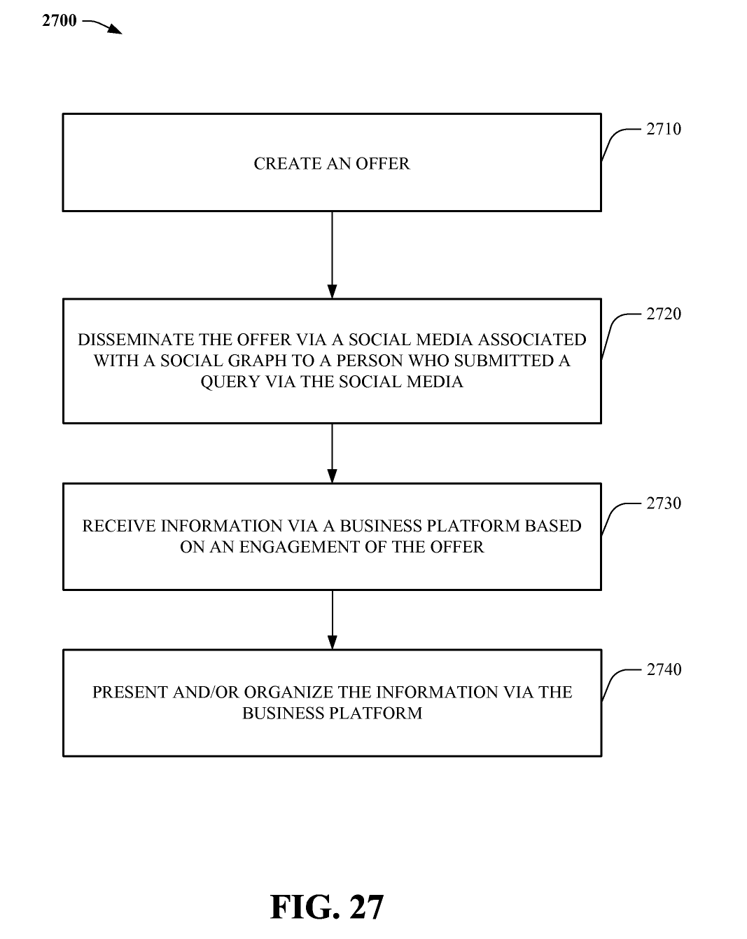

FIG. 27 illustrates a process associated with a person and/or a business subscribed to a social media, in accordance with an embodiment. At 2710, an offer can be created by at least one of a business associated with one or more social graphs of the social media or a person associated with the one or more social graphs. At 2720, the offer can be disseminated via the social media to a person who submitted a query via the social media. At 2730, the offer can be engaged, e.g., accepted, by a business or a person via the social media. For example, the offer can be a request for information related to a survey, and the business or the person can enter and submit the information at 2730. Moreover, the information can be received via a business platform, at 2730, based on engagement of the offer. At 2740, the information can be presented and/or organized via the business platform, e.g., for use by the business regarding one or more marketing activities.

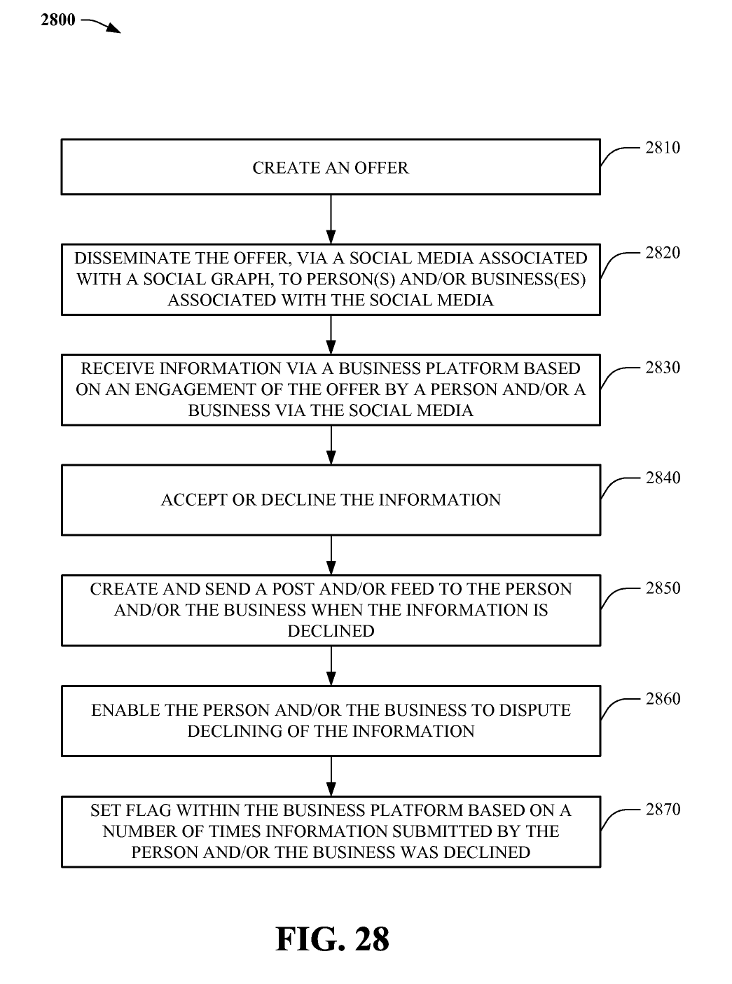

FIG. 28 illustrates another process associated with a business subscribed to a social media, in accordance with an embodiment. At 2810, an offer can be created by the business. At 2820, the offer can be disseminated, via a social media, to one or more persons or businesses associated with one or more social graphs related to the social media. At 2830, information entered by a person or an other business, based on an engagement, or an acceptance, of the offer received via a business platform. At 2840, the business can accept or decline the information entered at 2830. If the information is declined by the business, a post and/or feed, e.g., wall feed, can be created and sent to the person or the other business at 2850. In an aspect, the post can include the reason(s) the business declined the information, e.g., improper telephone number entered. At 2860, the person or the other business can dispute rejection of the information. A flag can be set, at 2870, based on a number of times information submitted by the person or the other business was declined, e.g., which can be used by the business to screen disseminating further offers to the person or the other business.

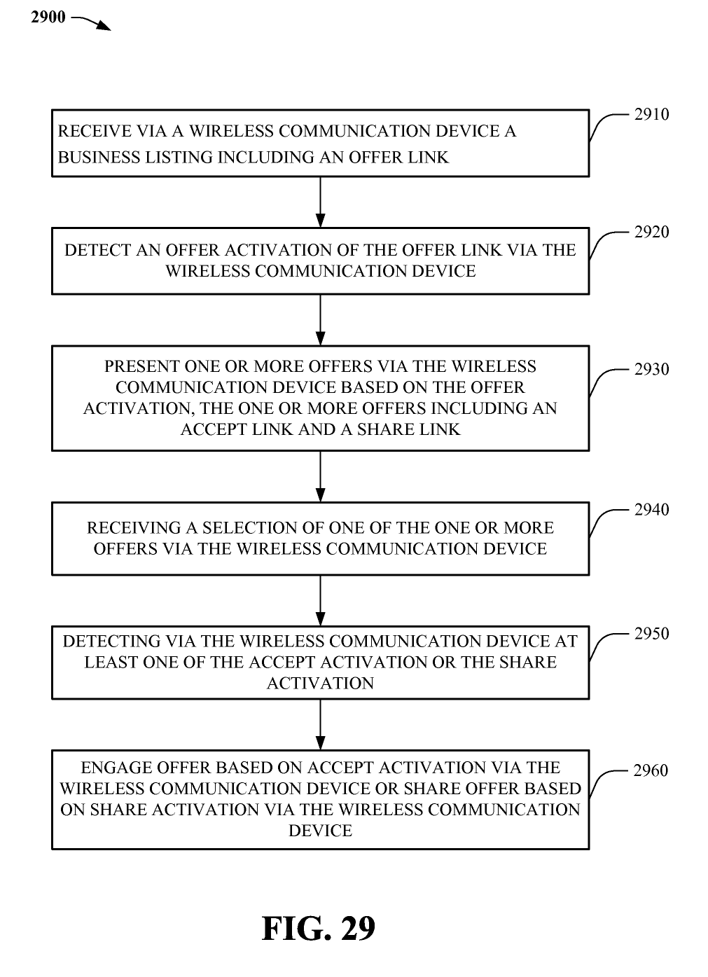

FIG. 29 illustrates a process 2900 implemented via a mobile device, in accordance with an embodiment. At 2910, a business listing including an offer link can be received via a wireless communication device. An offer activation of the offer link, via the wireless communication device, can be detected at 2920. At 2930, one or more offers can be presented via the wireless communication device based on the offer activation, the one or more offers including an accept link and a share link. A selection of one of the one or more offers can be received via the wireless communication device at 2940. At 2950, the accept activation and/or the share activation can be detected via the wireless communication device. The offer can be engaged, or accepted, at 2960 based on the accept activation; or the offer can be shared with one or more other wireless communication devices based on the share activation. In an aspect (not shown), an active sharing feature can be enabled by a person, e.g., of person(s) 122, via a social media component, e.g., social media component 130. As such, the social media component can automatically share one or more offers sent to a person of person(s) 122, via a social media, e.g., social media 110, to other person(s) of person(s) 122 associated with the social media.

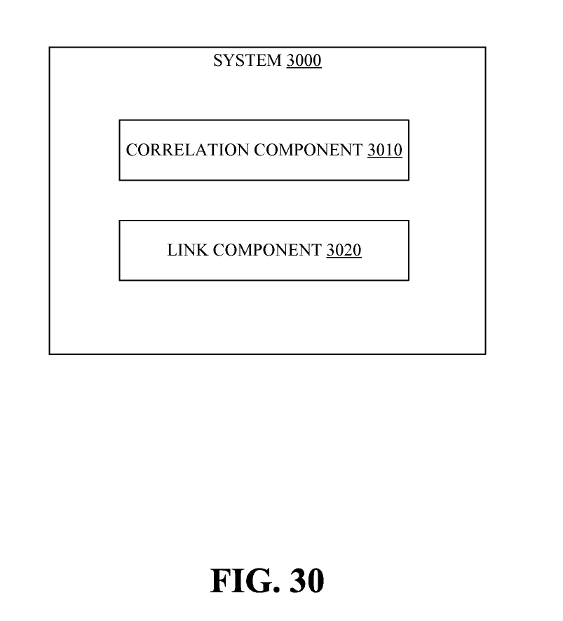

FIG. 30 illustrates a system for utilizing one or more social graphs, in accordance with an embodiment. System 3000 can include a correlation component 3010 and a link component 3020. Correlation component 3010 can be configured to receive an identity of at least one of a person or a business. For example, the identity can include a name, a telephone number, an email address, etc. associated with the at least one of the person or the business.

Further, correlation component 3010 can be configured to correlate the identity with one or more social graphs. For example, correlation component 3010 can identify a person or a business of the one or more social graphs based on the identity, e.g., associated with the name, the telephone number, the email address, etc. In addition, correlation component 3010 can be configured to identify one or more preferences, e.g., product(s) and/or service(s) searched for, recommended, purchased, etc. via the person or the business. In an aspect, correlation component 3010 can identify such preferences based on analyzing data associated with the person or the business, e.g., maintained in a database related to one or more advertisers, product and/or service providers, etc.

Link component 3020 can be configured to associate the person with at least one of an other person related to the one or more social graphs or an other business related to the one or more social graphs. Further, link component 3020 can be configured to provide information to the at least one of the other person or the other business based on, at least in part, the one or more preferences. In one aspect, link component 3020 can be configured to provide at least one of an advertisement or a recommendation for a product or a service to the at least one of the other person or the other business, based on, at least in part, the identity. As such, system 3000 can utilize one or more social graphs to provide information to and/or solicit/obtain information from person(s) and/or business(es) associated with one or more social graphs.

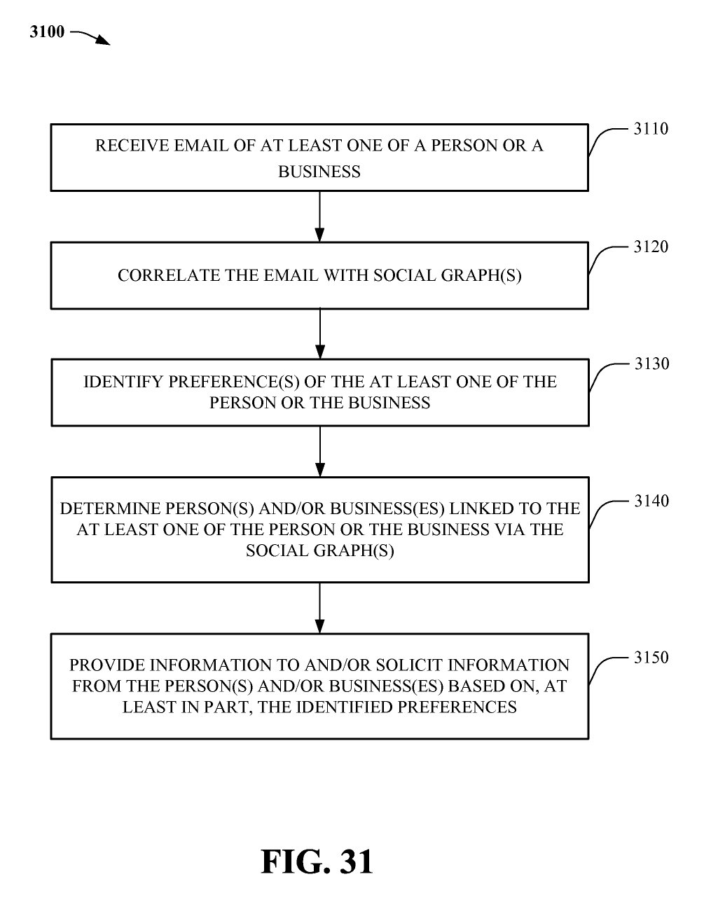

FIG. 31 illustrates a process 3100 for providing and/or soliciting information utilizing social graph(s), in accordance with an embodiment. At 3110, an email of at least one of a person or a business can be received, or obtained, e.g., via correlation component 3010. In another aspect, a name of a person and/or a business, and/or a telephone number of the person and/or the business, can be obtained. At 3120, the email (or in other aspects, the name, the telephone number, etc.) can be correlated, or associated with, one or more social graphs, which can link the person and/or the business to other person(s) and/or other business(es). At 3130, one or more preferences of the person and/or the business can be identified, e.g., via correlation component 3010. Other person(s) and/or business(es) linked to the at least one of the person or the business, via the one or more social graphs, can be determined, or identified, at 3140, e.g., via link component 3020. As such, at 3150, information can be provided and/or solicited from (e.g., via link component 3010), the other person(s) and/or the other business(es) based on the one or more preferences determined, or identified, at 3130.

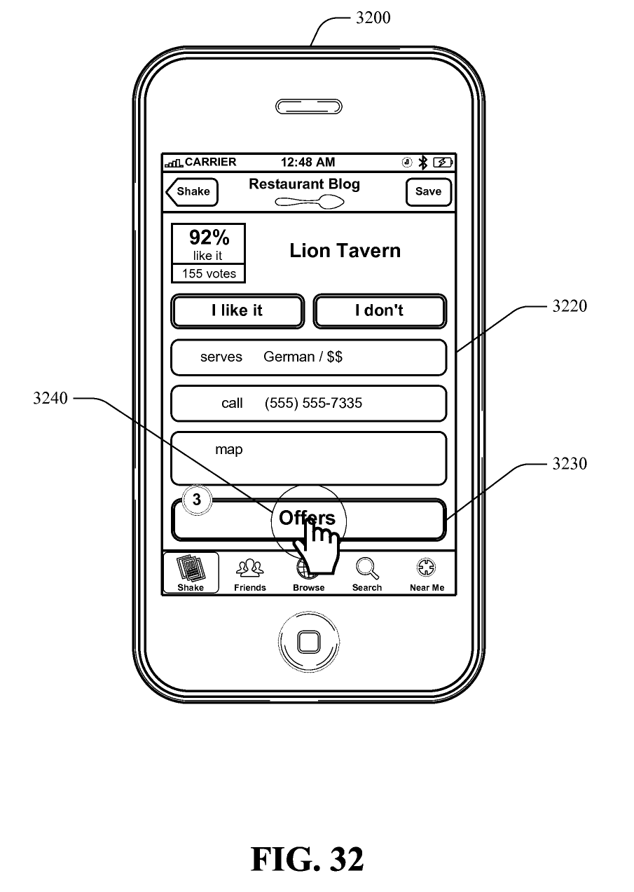

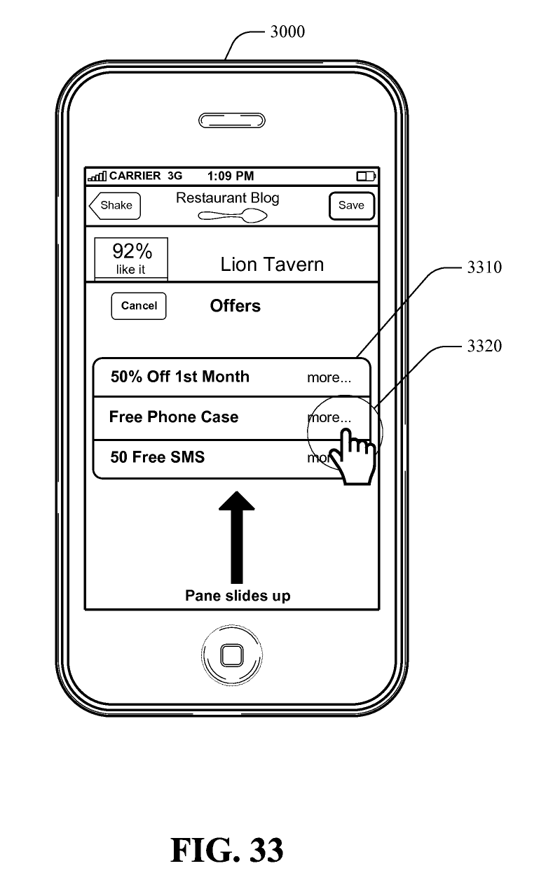

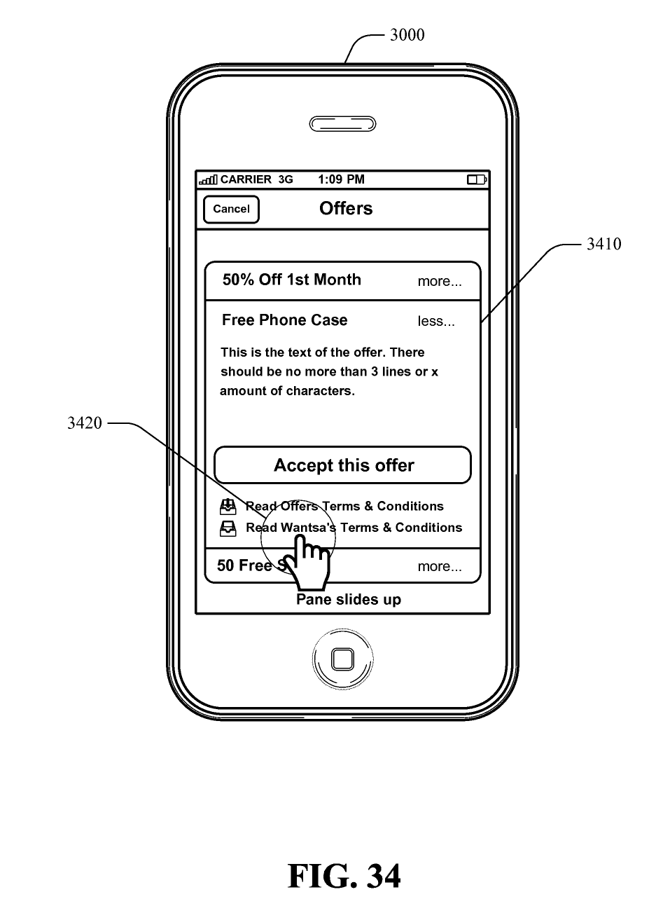

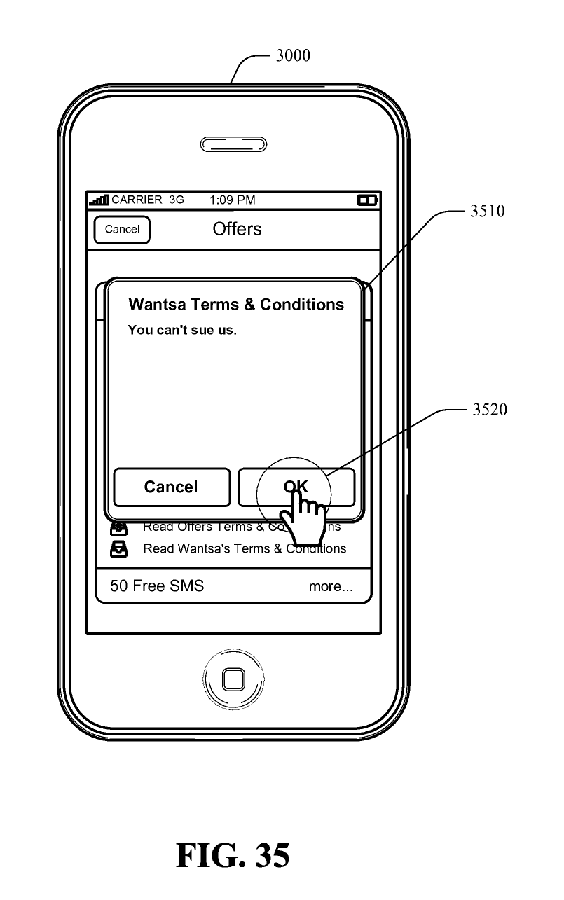

FIGS. 32-39 illustrate a mobile device 3200 implementing aspects of process 3200, in accordance with an embodiment. FIG. 32 depicts mobile device 3200 displaying a business listing 3220, an offer link 3230, and an offer activation 3240 occurring via mobile device 3200. FIG. 33 depicts mobile device 3200 displaying an offer list 3310 associated with three offers displayed by mobile device 3200 via a sliding pane. In an aspect (not shown), mobile device 3200 can display offer list 3310 without a sliding pane. In another aspect (not shown), mobile device 3200 can display at least two offers without a sliding pane. Further, FIG. 33 depicts an offer selection 3320 of one of the three offers. FIG. 34 depicts mobile device 3200 displaying further details 3410 of offer selection 3320. Moreover, FIG. 34 depicts mobile device 3200 displaying a view activation 3420 associated with terms and conditions of offer selection 3320. Terms and conditions 3510 of offer selection 3320 are displayed by mobile device 3200, as depicted by FIG. 35.

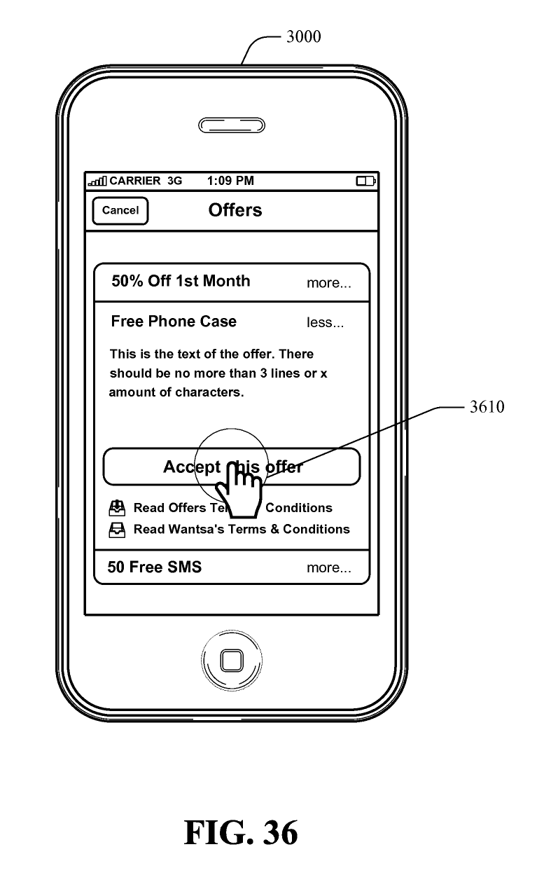

In addition, FIG. 35 depicts a terms and conditions acceptance 3520 occurring via mobile device 3200. In another aspect (not shown), acceptance, e.g., acceptance 3520, of terms and conditions is not required. FIG. 36 depicts an accept activation 3610 occurring via mobile device 3200. In an aspect, information can be sent to mobile device 3200, e.g., related to offer selection 3320 (e.g., see share activation 3710 below). Such information can be communicated and/or transferred to mobile device 3200 via, e.g., email, SMS protocol, MMS protocol, IM protocol, other message protocols, etc. In another aspect, the information and/or other information can be sent to a business and/or a person associated with offer selection 3320 via, e.g., email, SMS protocol, MMS protocol, IM protocol, other message protocols, etc. For example, such information and/or other information can be used by the business and/or the person to perform further actions associated with the offer.

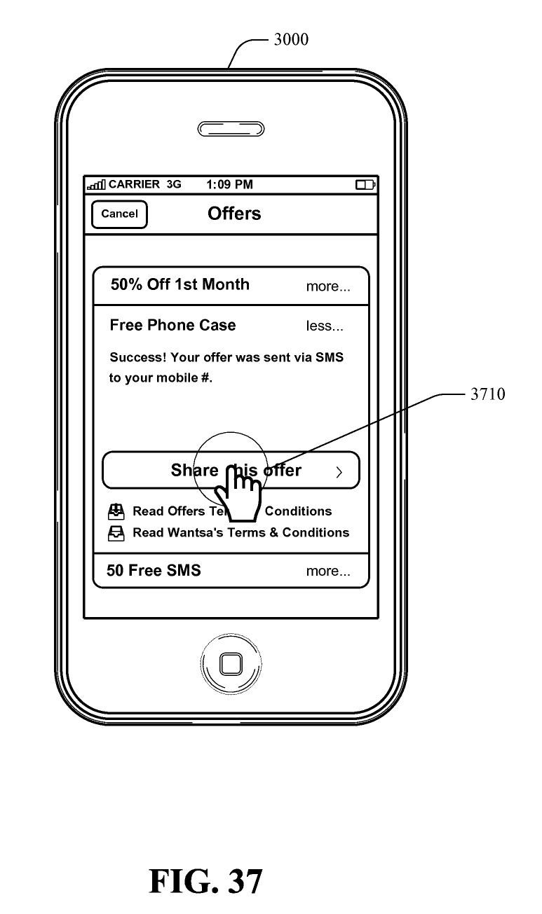

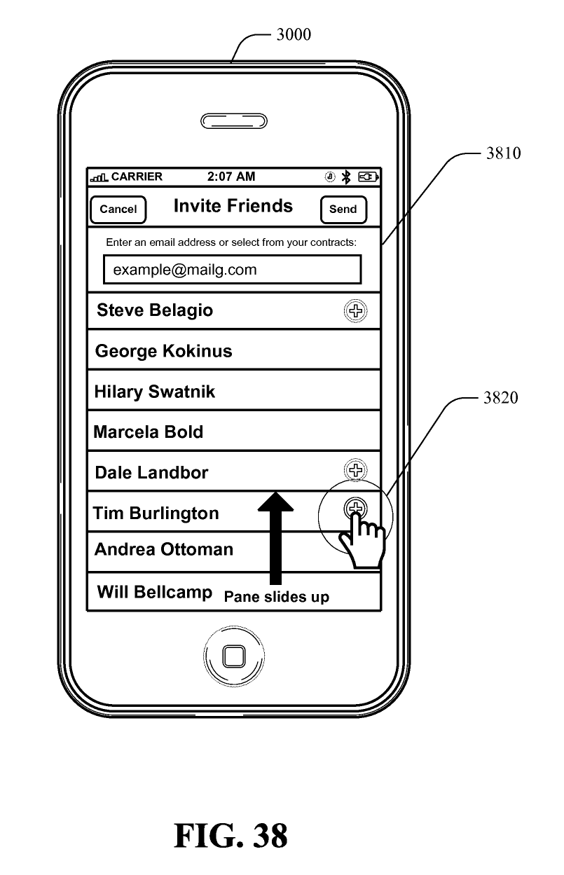

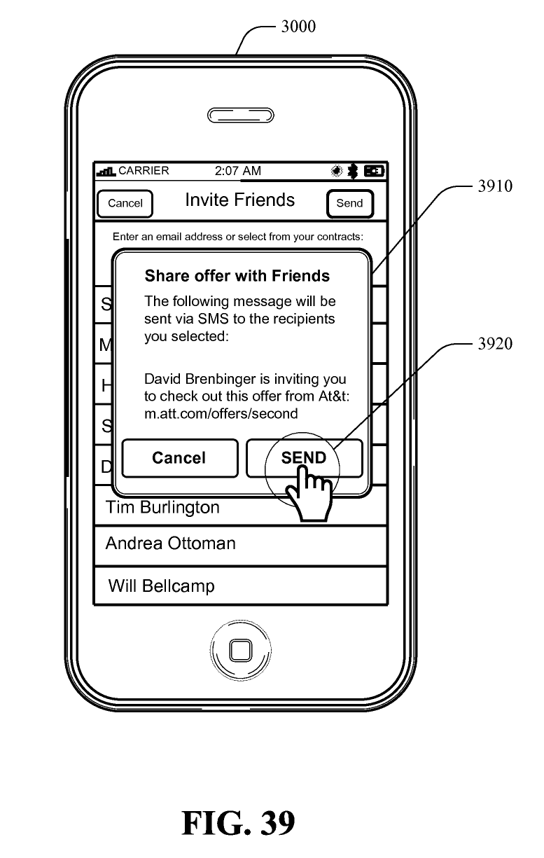

FIG. 37 depicts a share activation 3710 occurring via mobile device 3200. In an aspect (not shown), an active sharing feature can be enabled by a person, e.g., of person(s) 122, which can configure a social media component, e.g., social media component 130, to automatically share one or more offers sent to a person of person(s) 122, via a social media associated with mobile device 3200, e.g., social media 110, to other person(s) of person(s) 122 associated with the social media. As such, such other person(s), e.g., list of friends 3810 (see FIG. 38) can automatically receive, e.g., via other mobile device(s), etc. an offer associated with offer selection 3120. In another aspect, list of friends 3810 (see FIG. 38), e.g., associated with a social network community, e.g., social networking environment 100, can be displayed via mobile device 3200 upon share activation 3710. As such, FIG. 38 depicts a friend selection 3820 via mobile device 3200. FIG. 39 depicts a share confirmation message 3910 displayed via mobile device 3200 upon friend selection 3820. Further, FIG. 39 depicts another share activation (3920) occurring via mobile device 3200.

In another aspect (not shown), an offer request, or offer petition, can be submitted via mobile device 3200, e.g., via SMS protocol, MMS protocol, IM protocol, etc. to at least one person, business, and/or category of business. Further, an offer can be created by a business and/or person, and then displayed via mobile device 3200 in response to the offer request. Moreover, location detection technology associated with mobile device 3200, e.g., Global Positioning System (GPS) service(s) can be utilized to: present offers to users searching within a defined geographic area; verify acceptance of offers; share a request for offers (e.g., offer petition) etc. via mobile device 3200.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in social networking environments 100, 200, 300, 400, 600, 700, 900, 1100, 1300, 1500, 1600, 1700, etc.; data stores 350 and 1350, mobile device 3200, non-volatile memory 4022 (see below), disk storage 4024 (see below), and memory storage 4046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

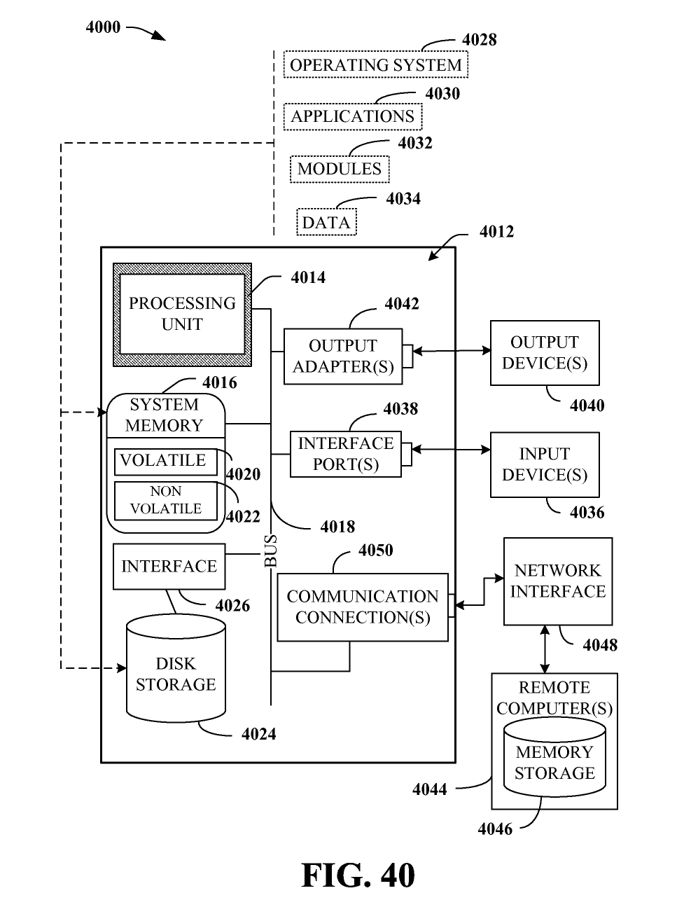

In order to provide a context for the various aspects of the disclosed subject matter, FIG. 40, and the following discussion, are intended to provide a brief, general description of a suitable environment in which the various aspects of the disclosed subject matter can be implemented, e.g., various processes associated with FIGS. 1-27. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 40, a block diagram of a computing system 4000 operable to execute the disclosed systems and methods is illustrated, in accordance with an embodiment. Computer 4012 includes a processing unit 4014, a system memory 4016, and a system bus 4018. System bus 4018 couples system components including, but not limited to, system memory 4016 to processing unit 4014. Processing unit 4014 can be any of various available processors. Dual microprocessors and other multiprocessor architectures also can be employed as processing unit 4014.

System bus 4018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 4016 includes volatile memory 4020 and nonvolatile memory 4022. A basic input/output system (BIOS), containing routines to transfer information between elements within computer 4012, such as during start-up, can be stored in nonvolatile memory 4022. By way of illustration, and not limitation, nonvolatile memory 4022 can include ROM, PROM, EPROM, EEPROM, or flash memory. Volatile memory 4020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 4012 also includes removable/non-removable, volatile/non-volatile computer storage media. FIG. 40 illustrates, for example, disk storage 4024. Disk storage 4024 includes, but is not limited to, devices like a magnetic disk drive, floppy disk drive, tape drive, Jaz drive, Zip drive, LS-100 drive, flash memory card, or memory stick. In addition, disk storage 4024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 4024 to system bus 4018, a removable or non-removable interface is typically used, such as interface 4026.

It is to be appreciated that FIG. 40 describes software that acts as an intermediary between users and computer resources described in suitable operating environment 4000. Such software includes an operating system 4028. Operating system 4028, which can be stored on disk storage 4024, acts to control and allocate resources of computer system 4012. System applications 4030 take advantage of the management of resources by operating system 4028 through program modules 4032 and program data 4034 stored either in system memory 4016 or on disk storage 4024. It is to be appreciated that the disclosed subject matter can be implemented with various operating systems or combinations of operating systems.

A user can enter commands or information, e.g., via interface component 830, into computer 4011 through input device(s) 4036. Input devices 4036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 4014 through system bus 4018 via interface port(s) 4038. Interface port(s) 4038 include, for example, a serial port, a parallel port, a game port, and a universal serial bus (USB). Output device(s) 4040 use some of the same type of ports as input device(s) 4036.

Thus, for example, a USB port can be used to provide input to computer 4012 and to output information from computer 4012 to an output device 4040. Output adapter 4042 is provided to illustrate that there are some output devices 4040 like monitors, speakers, and printers, among other output devices 4040, which use special adapters. Output adapters 4042 include, by way of illustration and not limitation, video and sound cards that provide means of connection between output device 4040 and system bus 4018. It should be noted that other devices and/or systems of devices provide both input and output capabilities such as remote computer(s) 4044.

Computer 4012 can operate in a networked environment using logical connections to one or more remote computers, such as remote computer(s) 4044. Remote computer(s) 4044 can be a personal computer, a server, a router, a network PC, a workstation, a microprocessor based appliance, a peer device, or other common network node and the like, and typically includes many or all of the elements described relative to computer 4012.

For purposes of brevity, only a memory storage device 4046 is illustrated with remote computer(s) 4044. Remote computer(s) 4044 is logically connected to computer 4012 through a network interface 4048 and then physically connected via communication connection 4050. Network interface 4048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 4050 refer(s) to hardware/software employed to connect network interface 4048 to bus 4018. While communication connection 4050 is shown for illustrative clarity inside computer 4012, it can also be external to computer 4012. The hardware/software for connection to network interface 4048 can include, for example, internal and external technologies such as modems, including regular telephone grade modems, cable modems and DSL modems, ISDN adapters, Ethernet cards, netbooks, virtual machines, e.g., associated with cloud computing, etc.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method comprising:
receiving a query via a social media from a person of two or more persons associated with at least one social graph, the social media associated with the at least one social graph; and
evaluating the query based on, at least in part, the at least one social graph.

2. The method of claim 1, further comprising:
transmitting the query via the social media, based on the evaluating, to at least one of:
one or more persons of the two or more persons associated with the at least one social graph; or
a business that is subscribed to the social media;
determining whether the at least one of the one or more persons or the business submitted a response to the query;
creating an interactive communication based on, at least in part, the determining; and
disseminating the interactive communication via the social media to at least one of:
the person;
the one or more persons; or
the business.

3. The method of claim 2, further comprising:
storing communication information associated with the interactive communication in a data store;
wherein the receiving further comprises receiving an other query via the social media;
wherein the evaluating further comprises evaluating the other query based on, at least in part, the communication information and the at least one social graph; and
wherein the creating further comprises creating the interactive communication based on, at least in part, the communication information.

4. The method of claim 3, further comprising:
receiving offer input from the one or more persons or the business;
creating an offer feed based on, at least in part, the offer input and the at least one social graph;
sending the offer feed to the person via the social media; and
storing offer information associated with the offer feed in the data store;
wherein the evaluating further comprises evaluating at least one of the query or the other query based on, at least in part, the communication information, the offer information, and the at least one social graph.

5. The method of claim 4, the creating further comprises:
creating the offer feed based on, at least in part, the offer input and the at least one social graph, the offer feed comprises a view link, an accept link, and an offer of at least one of an incentive, a discount, a benefit, or compensation in exchange for an action performed by the person;
wherein the action comprises, at least in part, an accept activation of the accept link; and
wherein the offer information is displayed via the social media based on a view activation of the view link.

6. The method of claim 5, the creating further comprises:
creating the offer feed based on at least one of:
the offer input; or
the at least one social graph.

7. The method of claim 6, further comprising:
transmitting a verification feed via the social media to the person based on, at least in part, the accept activation, wherein the verification feed comprises a yes link, a no link, and a request for the person to confirm whether the action was completed;
sending a confirmation message to the business based on, at least in part, a yes link activation of the yes link; and
at least one of:
prompting the person to cancel the action or submit another response based on, at least in part, a reject link activation of the no link; or
recording the reject link activation in the data store.

8. The method of claim 7, further comprising:
transmitting the verification feed via the social media to the person based on, at least in part, the accept activation.

9. The method of claim 2, the receiving further comprising:
receiving the query via a social networking website from the person, the person associated with the at least one social graph;
wherein the transmitting further comprises transmitting the query via the social networking website, based on the evaluating, to at least one of the one or more persons or the business;
wherein the determining further comprises determining whether the at least one of the one or more persons or the business submitted the response to the query; and
wherein the disseminating further comprises disseminating the interactive communication via the social networking website to at least one of:
the person;
the one or more persons; or
the business.

10. The method of claim 2, the disseminating further comprising:
disseminating the interactive communication via the social media to the at least one of:
the person;
the one or more persons; or
the business;
wherein the disseminating is based on a degree of separation between the person and the one or more persons.

11. The method of claim 2, the transmitting further comprising:
transmitting a search feed to at least one of the one or more persons or the business based on the evaluating;
wherein the search feed comprises a suggest link and one or more keywords associated with the query; and
wherein the response is submitted by the at least one of the one or more persons or the business based on an activation of the suggest link by the at least one of the one or more persons or the business.

12. The method of claim 11, the transmitting further comprising:
transmitting the search feed to at least one of the one or more persons or the business based on the evaluating;
wherein the search feed further comprises a graphical representation of the person; and
wherein the one or more keywords comprise a location associated with the query and a name of the person.

13. The method of claim 11, further comprising:
building a recommendation feed based on the activation of the suggest link, the recommendation feed comprising a ditto link, an other suggest link, a recommended name of a recommended person or business, and a name of one of the one or more persons, the one of the one or more persons activated the suggest link;
creating another recommendation feed based on an accord activation of the ditto link;
generating a confirmation feed comprising an accept link, a decline link, and the name based on the activation of the suggest link;
transmitting the confirmation feed to the recommended person or business;
receiving an accept activation of the accept link or a decline activation of the decline link from the recommended person or business;
disseminating the recommendation feed via the social media to the person based on the accept activation; and
sending a decline message to the one of the one or more persons based on the decline activation.

14. The method of claim 13, the building comprising:
building the recommendation feed based on the activation of the suggest link or an activation of the ditto link, the recommendation feed further comprising a graphical representation of the one of the one or more persons.

15. The method of claim 5, further comprising:
transmitting an action feed via the social media to the one or more persons based on, at least on part, the accept activation;
wherein the action feed comprises an other view link, a name of the person, a name of the business, a graphical representation of the person, and action information associated with the action; and
wherein the offer information is displayed via the social media based on a link activation of the other view link.

16. The method of claim 2, further comprising:
sending a message via the social media to the person when no response was submitted to the query;
receiving information from the person;
creating an offer petition based on the information; and
sending an offer petition feed via the social media to at least one of the one or more persons or the business, the offer petition feed comprising the offer petition and at least one of a name of the person or another name associated with another person.

17. A method comprising:
receiving a search communication via a social media environment associated with at least one social graph of at least two members of the social media environment;
querying historical search information via a database associated with the social media environment based on the search communication and the at least one social graph; and
soliciting one or more recommendations via the social media environment, based on the querying, from the at least one of:
a member of the at least two members of the social media environment; or
a business of one or more businesses subscribed to the social media environment.

18. The method of claim 17, further comprising:
presenting at least one interactive post via the social media environment to the at least two members of the social media environment based on the at least one social graph and at least one of the one or more recommendations or the historical search information; and
storing the at least one interactive post in the database as other historical search information.

19. The method of claim 18, further comprising:
determining at least one of:
a number of recommendations of the one or more recommendations associated with a business; or
proximity of a location of the business to a search location associated with the search communication; and
filtering the one or more recommendations via the social media environment based on, at least in part, the determining.

20. The method of claim 17, wherein the receiving further comprises:
receiving the search communication via the social media environment associated with the at least one social graph of the at least two members of the social media environment;
wherein the search communication comprises at least one of:
a search feed submitted by a first member of the at least two members for broadcast via the social media environment, the search feed comprising a query;
a recommendation feed submitted by a second member of the at least two members for broadcast via the social media environment based on the search feed, wherein the recommendation feed comprises a recommendation by the second member, wherein the recommendation feed comprises a ditto link that, when activated by a third member of the at least two members, creates an interactive post of the at least one interactive post agreeing with the recommendation feed, and wherein the interactive post comprises a name of the third member;
a confirmation feed for broadcast to the member via the social media environment based on, at least in part, the recommendation feed, the confirmation feed comprising a request for acceptance of the recommendation feed by the member;
an offer feed submitted by at least one of a member of the at least two members or a business of the one or more businesses subscribed to the social media environment for broadcast to the first member via the social media environment based on the search feed, the offer feed comprising an offer of at least one of an incentive, a discount, a benefit, or compensation in exchange for an action performed by the first member;
a verification feed for broadcast to the first member via the social media environment, the verification feed comprising a request for the first member to confirm whether the action was performed;
an action feed for broadcast via the social media environment comprising information associated with the action performed by the first member;
an offer petition feed submitted by a fourth member of the at least two members of the social media environment for broadcast via the social media environment, the offer petition feed comprising a petition for the offer feed;
a group offer petition feed submitted by a fifth member of the at least two members of the social media environment for broadcast via the social media environment, the group offer petition feed inviting other members of the at least two members to join a group petition and send the group petition for the offer feed; or
a share offer feed submitted by a sixth member of the at least two members of the social media environment for broadcast via the social media environment, the share offer feed comprising the offer feed.

21. The method of claim 20, wherein the search communication further comprises at least one of: a social network community feed, an interactive news feed, a short message service (SMS) feed, a multimedia messaging service (MMS) feed, an instant messaging (IM) feed, a rich site summary (RSS) feed, or an extensible markup language (XML) feed.

22. The method of claim 20, further comprising:
donating a percentage of advertising revenue generated when the first member accepts the offer to at least one of a cause or a charity selected by the first member.

23. The method of claim 20, wherein the offer comprises at least one of:
a purchase offer associated with selling the product or the service;
a complete form offer associated with completing a form;
a survey offer associated with completing a survey;
a poll offer associated with completing a poll;
a coupon offer associated with receiving at least one of the product or the service;
a branding offer associated with advertising via the social media environment; or
a classified offer associated with agreeing to be associated with a person who posted the classified offer or a business who posted the classified offer.

24. A system comprising:
means for receiving an interactive search feed from at least one member of members of an Internet-based social network via the Internet-based social network; and
means for querying information associated with at least one prior interactive search feed based on the interactive search feed.

25. The system of claim 24, further comprising:
means for soliciting, based on the querying, at least one of:
a recommendation from at least one other member of the members of the Internet-based social network; or
an offer from a business subscribed to the Internet-based social network; and
means for at least one of:
disseminating the recommendation to the at least one member and the at least one other member via the Internet-based social network; or
disseminating the offer to the at least one member.

26. A method comprising:
determining a demographic profile of at least one of a customer or a potential customer of a business;
subscribing the business to at least one search feed submitted by at least one member of an online community via the online community based on at least one keyword; and
extrapolating information related to the at least one member based on at least one social graph of the online community.

27. The method of claim 26, further comprising
creating an interactive offer based on the demographic profile, the subscribing, and the information; and
presenting the interactive offer to the at least one member via the online community based on the creating.

28. The method of claim 26, further comprising:
creating an auction between the business and at least one other business to bid for an order of priority associated with presenting offers via the online community to one or more members of the online community based on the at least one social graph; and
presenting the offers via the online community by respective businesses based on the order of priority.

29. A method comprising:
receiving via a wireless communication device at least one of:
an offer request for one or more offers; or
a business listing comprising an offer link;
detecting an offer activation of the offer link via the wireless communication device; and
presenting one or more offers via the wireless communication device based on at least one of the offer request or the offer activation;
wherein the one or more offers comprise an accept link and a share link;
wherein an offer of the one or more offers is accepted via an accept activation of the accept link via the wireless communication device; and
wherein the offer is at least one of:
shared with one or more other wireless communication devices via a share activation of the share link via the wireless communication device; or
automatically shared with the one or more wireless communication devices based on the presenting.

30. The method of claim 29, further comprising:
receiving a selection of one of the one or more offers via the wireless communication device;
detecting via the wireless communication device at least one of the accept activation or the share activation; and
at least one of:
accepting the offer based on the accept activation; or
sharing the offer based on at least one of the accept activation or the share activation.

31. A system comprising:
a correlation component configured to:
receive an identity of at least one of a person or a business;
correlate the identity with one or more social graphs; and
identify one or more preferences associated with the at least one of the person or the business; and
a link component configured to:
associate the person with at least one of an other person related to the one or more social graphs or an other business related to the one or more social graphs; and
at least one of:
provide information to the at least one of the other person or the other business based on, at least in part, the one or more preferences; or
solicit information from the at least one of the other person or the other business based on, at least in part, the one or more preferences.
